(19) United States
(12) Patent Application Publication
(10) Pub. No.: US 2026/0094074 A1
(43) Pub. Date: Apr. 2, 2026

(54) INFORMATION PROCESSING APPARATUS, DEVICE INFERENCE SYSTEM, AND INFERENCE PROCESSING METHOD

(71) Applicant: CANON KABUSHIKI KAISHA, Tokyo (JP)

(72) Inventor: KENTA YABE, Kanagawa (JP)

(21) Appl. No.: 19/342,828

(22) Filed: Sep. 29, 2025

(30) Foreign Application Priority Data
Oct. 2, 2024 (JP) 2024-173481

(51) Int. Cl. G06N 20/20

(52) U.S. Cl. CPC G06N 20/20

(57) ABSTRACT

An information processing apparatus having a communication unit is provided. The apparatus obtains a copy of a first machine learning model from a first device that is connected via the communication unit, includes the first machine learning model, and is controlled based on a result of inference processing by the first machine learning model, holds the obtained copy of the first machine learning model in the at least one memory, and executes, in response to a request for inference processing for a second device, the inference processing that uses the copy of the first machine learning model held in the at least one memory.

### BACKGROUND

### Field of the Technology

Matters of the present disclosure relate to an information processing apparatus, a device inference system, and an inference processing method.

### Description of the Related Art

In recent years, the introduction of AI technology into a device is an important tool for enhancing the value and competitive power of the device. The range supported by AI is becoming diverse day by day; this is contributing to automation, streamlining, and quality improvements of tasks that use a device.

Conventionally, as the execution of inference processing by AI has required reasonable computing resources, it has been often limited to a remote execution via a network.

However, due to improvements in the performance of information devices in addition to the evolution of tuning technology, such as a reduction in the processing load of a machine learning model, it has become realistic for AI to execute inference processing on an edge device alone.

Furthermore, a combination of a conventional remote execution of inference processing by AI and a local execution thereof on an edge device has led to the appearance of a device characterized by the execution of inference processing by AI on an edge device in a case where responsiveness is desired, and the execution thereof in a remote environment in a case where higher levels of accuracy and general versatility are desired (e.g., see non-patent document 1).

Some edge devices use a pre-installed machine learning model, whereas other edge devices select, install, and use an optimal model based on information of an environment in which the edge devices are placed (e.g., see International Publication No. 2020/105161).
[Non-Patent Document 1]Sharp Corporation, “Talking freely with home appliances comes true?!—About ‘CE-LLM’: Sharp's people-oriented edge AI technology”, [online], Mar. 28, 2024, Sharp Blog, [Retrieved on Sep. 13, 2024], the Internet, <URL: https://blog.sharp.co.jp/2024/03/28/44007/>

However, a machine learning model changes into a form suitable for the intention of a user by conducting learning repeatedly as appropriate. For example, in a case where an edge device is a device like a home appliance product, a machine learning model clearly reflects the individual properties of users by conducting learning using pieces of learning data of the respective users.

Although the inventions indicated as prior art are characterized by the use of a machine learning model appropriate for an environment in which an edge device is placed, the obtained result of inference processing using the model is not necessarily optimal for a user of that device.

### SUMMARY

The technology of the present disclosure has been made in view of the aforementioned conventional examples, and aims to obtain an inference processing result appropriate for a user by using a machine learning model that has been caused to conduct learning by the user also on a device that is not equipped with that machine learning model.

According to an aspect of the present disclosure, provided is an information processing apparatus, comprising: a communication unit; at least one memory storing instructions; and at least one processor that is in communication with the at least one memory and that, when executing the instructions, cooperates with the at least one memory to execute processing, the processing including obtaining a copy of a first machine learning model from a first device that is connected via the communication unit, includes the first machine learning model, and is controlled based on a result of inference processing by the first machine learning model, holding the obtained copy of the first machine learning model in the at least one memory, and executing, in response to a request for inference processing for a second device, the inference processing that uses the copy of the first machine learning model held in the at least one memory.

According to another aspect of the present disclosure, provided is an inference system, comprising: a first device that includes a first machine learning model and is capable of executing inference processing using the first machine learning model; a second device that includes a second machine learning model and is capable of executing inference processing using the second machine learning model; and an information processing apparatus, wherein the information processing apparatus includes: a communication unit; at least one memory storing instructions; and at least one processor that is in communication with the at least one memory and that, when executing the instructions, cooperates with the at least one memory to execute processing, the processing including obtaining a copy of the first machine learning model from the first device connected via the communication unit, holding the obtained copy of the first machine learning model in the at least one memory, and in a case where a setting has been configured to use the copy of the first machine learning model for a request for inference processing for the second device, executing, in response to the request for the inference processing for the second device, the inference processing that uses the copy of the first machine learning model held in the at least one memory.

The foregoing configuration makes it possible to obtain an inference processing result appropriate for a user by using a machine learning model that has been caused to conduct learning by the user also on a device that is not equipped with that machine learning model.

Features of the present disclosure will become apparent from the following description of embodiments with reference to the attached drawings. The following description of embodiments is described by way of example.

### BRIEF DESCRIPTION OF THE DRAWINGS

FIG. 1 is an overall diagram of a system.

FIG. 2A is a diagram of a hardware configuration of devices.

FIG. 2B is a diagram of a hardware configuration of a terminal.

FIG. 2C is a diagram of a hardware configuration of servers.

FIG. 3A is a diagram of a software configuration of a device application.

FIG. 3B is a diagram of a software configuration of a terminal application.

FIG. 3C is a diagram of a software configuration of a device management server application.

FIG. 3D is a diagram of a software configuration of a device service application.

FIG. 4A is a diagram showing an examples of a device registration screen.

FIG. 4B is a diagram showing an examples of a device registration screen.

FIG. 4C is a diagram showing an examples of a device registration screen.

FIG. 4D is a diagram showing an examples of a device registration screen.

FIG. 4E is a diagram showing an examples of a device registration screen.

FIG. 4F is a diagram showing an examples of a device registration screen.

FIG. 5 is a sequence diagram of device registration.

FIG. 6A is a sequence diagram of execution of inference processing.

FIG. 6B is a sequence diagram of execution of inference processing.

FIG. 7A is a diagram showing examples of an inference screen.

FIG. 7B is a diagram showing examples of an inference screen.

FIG. 8A is a diagram showing an example of a device detail information screen.

FIG. 8B is a diagram showing an example of a device detail information screen.

FIG. 8C is a diagram showing an example of a device list screen.

FIG. 9 is a sequence diagram of carriage of a model.

FIG. 10A is a diagram showing an example of an unowned device registration screen.

FIG. 10B is a diagram showing an example of an unowned device registration screen.

FIG. 10C is a diagram showing an example of an unowned device registration screen.

FIG. 10D is a diagram showing an example of an unowned device registration screen.

FIG. 10E is a diagram showing an example of an unowned device registration screen.

FIG. 11 is a sequence diagram of registration of an unowned device.

FIG. 12A is a sequence diagram of execution of inference processing on an unowned device.

FIG. 12B is a sequence diagram of execution of inference processing on an unowned device.

FIG. 13A is a diagram showing an example of an unowned device indirect registration screen.

FIG. 13B is a diagram showing an example of an unowned device indirect registration screen.

FIG. 13C is a diagram showing an example of an unowned device indirect registration screen.

FIG. 13D is a diagram showing an example of an unowned device indirect registration screen.

FIG. 14A is a sequence diagram of indirect registration of an unowned device.

FIG. 14B is a sequence diagram of indirect registration of an unowned device.

FIG. 15 is a sequence diagram of execution of indirect inference processing on an unowned device.

FIG. 16 is a diagram showing an example of a model deletion setting screen.

FIG. 17A is a flowchart of model deletion processing.

FIG. 17B is a flowchart of model deletion processing.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

The present embodiment will be described in relation to a system in which, for example, a machine learning model provided in a device owned by a user is copied and held by a terminal apparatus, and which can execute inference processing that uses the machine learning model held by the terminal apparatus in accordance with a selection when using a device of the same model as that device. Copying a machine learning model from a device and holding the copy by a terminal may be referred to as carrying a machine learning model.

### Hardware of Device Inference System

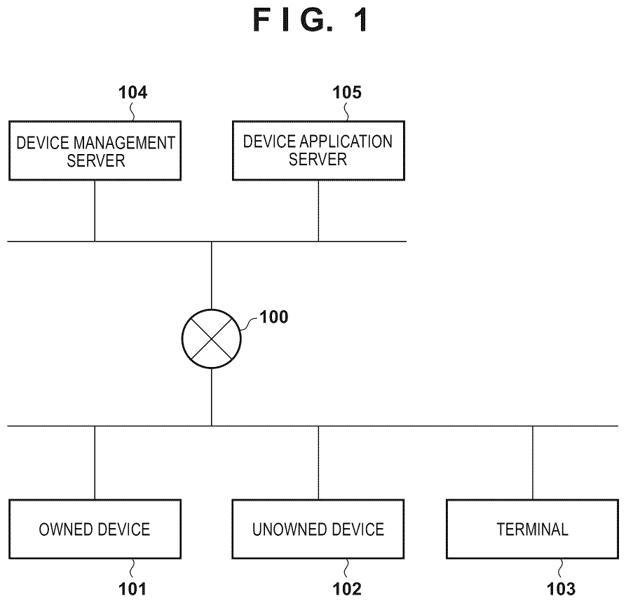

FIG. 1 is a diagram showing an overall configuration of a device inference system (or an information processing system) according to the present invention. A network 100 is a communication network that connects among constituent elements of the present system. The network 100 is, for example, a communication network, such as the Internet, realized by a local area network (hereinafter referred to as LAN), a wide area network (hereinafter referred to as WAN), a telephone line, a dedicated digital line, an ATM or frame relay line, a cable television line, a radio line for data broadcast, and the like. The network 100 may be of any type as long as data transmission/reception can be performed among constituent elements.

The present embodiment will be described on the precondition that the network 100 is the Internet in connection between a device management server 104 and a device application server 105. Also, the description will be provided on the precondition that the network 100 is an intranet in connection among an owned device 101, an unowned device 102, and a terminal 103.

Each of the owned device 101 and the unowned device 102 is an apparatus with a function of connecting to the network 100, and a function of solely executing inference processing that uses a machine learning model. Specifically, each of them is an apparatus with later-described functions in addition to original functions of the apparatus, such as a home appliance product and an image forming apparatus. Note that although the present embodiment will be described on the precondition that the owned device 101 and the unowned device 102 are home appliance products, the type of the apparatuses is not limited as long as they have two functions: the function of connecting to the network, and the function of executing inference processing that uses a machine learning model. For example, they may be image forming apparatuses, such as inkjet printers and digital multi-functional peripherals. Such apparatuses can use a machine learning model to suggest recommended settings, such as print settings, scan settings, and a data transmission destination corresponding to print data and a document.

Furthermore, although the owned device 101 and the unowned device 102 are described separately in the present embodiment, it is a precondition that, as apparatuses, they are of the same model and have the same functions and specifications. The owned device 101 and the unowned device 102 may be referred to as a first device and a second device, respectively. Also, in the following description, the owned device 101 and the unowned device 102 may be referred to as a device 101 and a device 102, respectively.

The terminal 103 is a client terminal that has a function of connecting to the network 100, and connects to the device 101, the unowned device 102, the device management server 104, and the device application server 105. In addition, the terminal 103 is a terminal with a function of solely executing inference processing that uses a machine learning model. Specifically, it is a mobile terminal, such as a smartphone, or a personal computer (PC). Note that although the present embodiment will be described on the precondition that the terminal 103 is a smartphone, the type of the apparatus is not limited as long as it has two functions similarly to the devices 101 and 102: the aforementioned function of connecting to the network, and the aforementioned function of executing inference processing that uses a machine learning model.

The device management server 104 is a server computer that manages information of the device 101 and the unowned device 102. An owner of a device registers information of the device and information of the terminal 103 with the server 104. This enables the owner of the device to execute an inference processing function of the device. In the present embodiment, a device that is registered with the device management server 104 in association with the terminal 103 is referred to as an owned device. Other devices are referred to as unowned devices. In the present system, there is always one owner for a device. Therefore, an owned device for a certain user of the present system is an unowned device for another user.

The device application server 105 is a server computer with a function of connecting to the network 100, and a function of solely executing inference processing that uses a machine learning model. The device application server 105 exists in accordance with a device(s). For example, in a case where there are a plurality of devices of different types, such as a cooking home appliance and an air-conditioning home appliance, device application servers 105 that respectively correspond to the cooking home appliance and the air-conditioning home appliance exist, and they respectively provide services to the corresponding devices 101 and 102. In the present embodiment, as it is assumed that the device 101 and the unowned device 102 are of the same model, the same device application server 105 provides services thereto. Furthermore, the device application server 105 provide services also to the terminal 103, which is associated with the devices in the device management server 104. Note that device application servers 105 that respectively correspond to a plurality of types of devices may be servers in which items of hardware are independent of each other, or may be logical or virtual servers that share one item of hardware.

In the illustration of FIG. 1, each constituent element is configured as one element to simplify the description of the present embodiment. However, there is no intention to restrict or limit the number of elements in terms of configurations. Each constituent element may be composed of one or more, or a plurality of, elements.

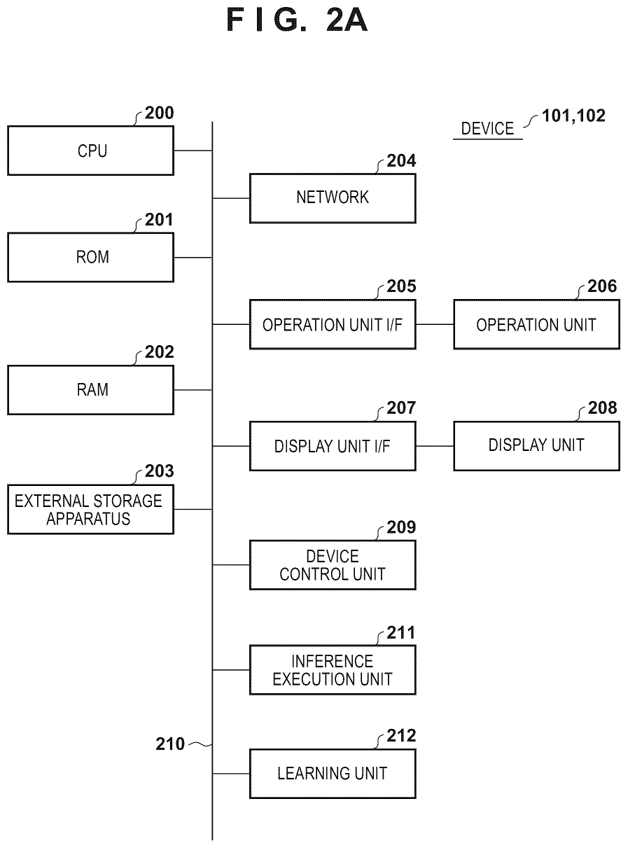

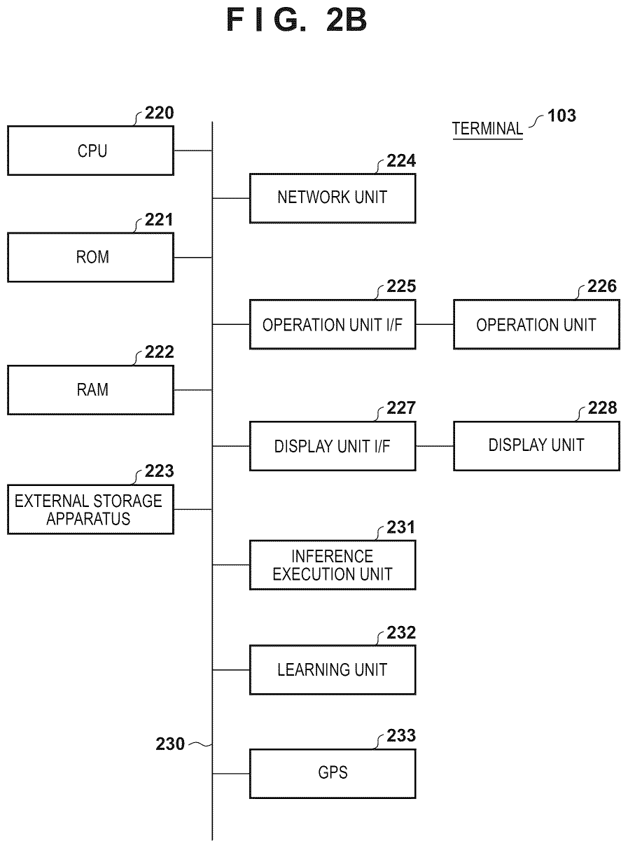

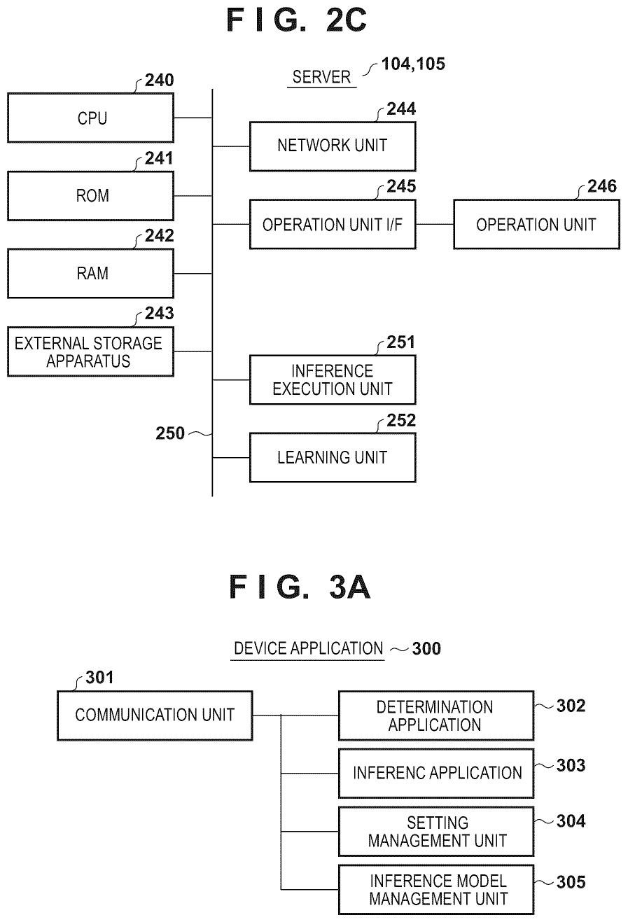

FIG. 2A, FIG. 2B, and FIG. 2C show hardware configurations of the devices 101 and 102, the terminal 103, and the servers 104 and 105, respectively. FIG. 2A is a block diagram showing a general hardware configuration of the devices 101 and 102 according to the present embodiment. Note, similarly to the device 101 and the unowned device 102 that may be respectively referred to as the first device and the second device for distinction, the resources, software modules, and the like included in each device may also be distinguished by the term “first” or “second” appended thereto.

A CPU 200 starts an OS using a boot program stored in a ROM 201. Also, the CPU 200 executes various types of processing by executing, on this OS, an application program stored in an external storage apparatus 203.

A RAM 202 is used as a working area for the CPU 200. The external storage apparatus 203 stores the aforementioned application program, a machine learning model used by an inference execution unit 211 and a learning unit 212, and various types of data, such as settings and history information of the device. An HDD or an SSD is applied as the external storage apparatus 203.

A network unit 204 connects to the network 100, and communicates with each element that composes the device inference system. The CPU 200 may be referred to as a processor, a control unit, or a processing unit.

An operation unit interface (I/F) 205, a display unit I/F 207, a device control unit 209, the inference execution unit 211, and the learning unit 212 are connected to the CPU 200 via a system bus 210, together with the ROM 201 and the RAM 202.

The operation unit I/F 205 is an interface that connects the device and an operation unit 206. The operation unit 206 transmits user input data that has been accepted by an input unit, which is a keyboard, a hardware key, a microphone, or the like and accepts inputting of an operation or the like by a user, to the CPU 200 via the operation unit I/F 205.

The display unit I/F 207 is an interface that connects the device and a display unit 208. The display unit 208 is an output unit, such as a display and a speaker, and outputs data transmitted from the CPU 200 via the display unit I/F 207. Furthermore, there is also an element that has functions of both of the operation unit 206 and the display unit 208, like a touch panel; in this case, it is connected to both of the I/Fs 205 and 207. The operation unit 206 and the display unit 208 may be collectively referred to as a user interface (UI) unit.

The device control unit 209 performs operational control on the device so as to realize device operations based on the application program executed by the CPU 200. Assume that the device 101 is a microwave oven. For example, in a case where the user has selected a heating function, the CPU 200 drives constituent elements necessary for executing the heating function, specifically a heater, a fan, a sensor, and the like, via the device control unit 209, or transmits a control instruction for controlling these constituent elements.

The inference execution unit 211 executes inference processing in the application program executed by the CPU 200. The inference execution unit 211 is an apparatus appropriate for inference processing that uses the machine learning model, such as a neural processing unit (NPU) and a graphics processing unit (GPU). Depending on the scale of the machine learning model, the inference processing may be executed by the CPU 200, rather than by the inference execution unit 211.

The learning unit 212 obtains the result of the inference processing executed by the inference execution unit 211, and executes re-learning processing of the machine learning model stored in the external storage apparatus 203. While examples of methods of the re-learning processing include supervised learning, unsupervised learning, and the like, a method appropriate for the device may be adopted. For example, if the user can change or adjust settings related to an output or an operation of the device through control that uses the result obtained in the inference processing by the machine learning model, supervised learning can be applied by using setting values after the change or the adjustment as supervisory data. In the case of a device that does not receive, or is not expected to receive, a feedback from the user, learning may be performed through unsupervised learning.

Note that in the present embodiment, the details of the inference processing and the re-learning processing of the machine learning model are not mentioned.

FIG. 2B is a block diagram showing a general hardware configuration of the terminal 103 according to the present embodiment. As basic constituent elements are similar to those of the devices 101 and 102 described above, a description of overlapping constituent elements is omitted. The present embodiment will be described on the precondition that the terminal 103 is a mobile terminal, such as a smartphone.

A CPU 220, a ROM 221, a RAM 222, an external storage apparatus 223, a network unit 224, an operation unit I/F 225, an operation unit 226, a display unit I/F 227, a display unit 228, a system bus 230, an inference execution unit 231, and a learning unit 232 are the same as constituent elements in each of the devices 101 and 102. A global positioning system module (GPS) 213 performs positioning and obtains position information of the terminal 103. Another positioning system may be used in place of the GPS.

FIG. 2C is a block diagram showing a general hardware configuration of the device management server 104 and the device application server 105 according to the present embodiment. As basic constituent elements are similar to those of the devices 101 and 102 and the terminal 103 described above, a description of overlapping constituent elements is omitted.

A CPU 240, a ROM 241, a RAM 242, an external storage apparatus 243, a network unit 244, an operation unit I/F 245, an operation unit 246, a system bus 350, an inference execution unit 251, and a learning unit 252 are the same as constituent elements in the terminal 103. As a characteristic of the servers, the servers exchange information with each element that composes the device inference system through communication via the network 100. Therefore, the display unit I/F 207 and the display unit 208 are not indispensable in the servers. It goes without saying that the servers may be configured to include these.

### Software of Device Inference System

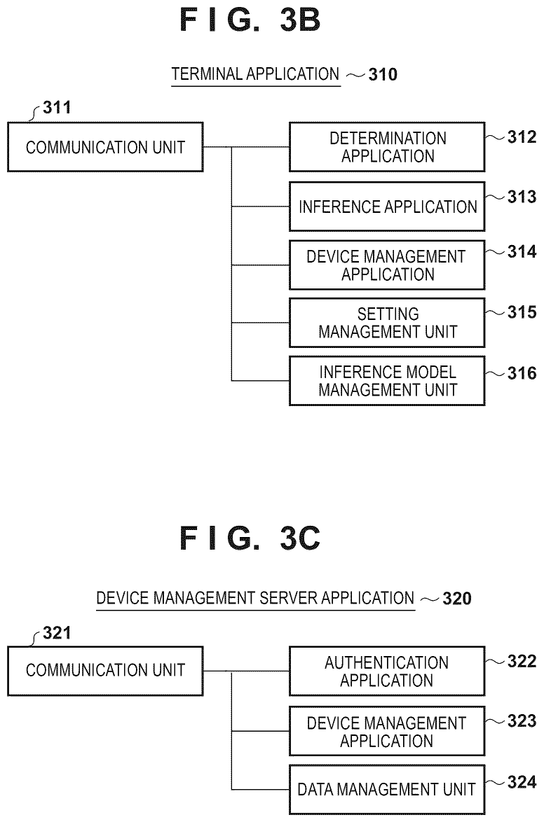

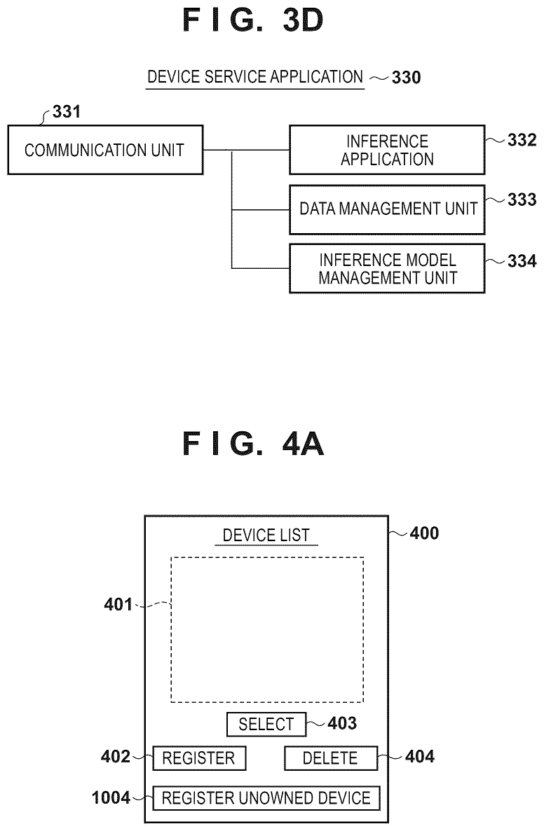

FIG. 3A-FIG. 3D are block diagrams showing a software configuration of each constituent element of the device inference system according to the present embodiment. These are application programs; they are stored in one of the ROM 201, the RAM 202, and the external storage apparatus 203 of each apparatus shown in FIG. 2A, FIG. 2B, and FIG. 2C, and executed by the CPU 200.

Note that each of the block diagrams shown in FIG. 3A-FIG. 3D is an excerpt of only software related to the present embodiment. Provided that the device 101 is a microwave oven, for example, items of software for realizing functions unique to the device, such as a heating application and an air lowing application, exist in reality; however, these are omitted.

In FIG. 3A, a device application 300 is an application program with a function of executing an inference processing sequence in the devices 101 and 102. The device application 300 includes a communication unit 301, a determination application 302, an inference application 303, a setting management unit 304, and an inference model management unit 305.

The communication unit 301 transmits and receives data to and from the terminal 103, the device management server 104, and the device application server 105 via the network 100.

In response to a user's request accepted by the operation unit 206, the determination application 302 determines which one of the device 101 and the device application server 105 is an optimal executor of the inference processing, and transmits an inference processing execution request to the inference application 303 or an inference application 332 of the device application server 105 in accordance with a determination result. Also, in a case where a later-described device management application 314 of the terminal 103 has configured a setting to execute the inference processing on the terminal 103, the determination application 302 transmits an inference processing execution request to an inference application 313 of the terminal 103. Furthermore, upon receiving a user's response accepted by the operation unit 206 with respect to the result of the inference processing executed by one of the device 101, the terminal 103, and the device application server 105, the determination application 302 judges whether to continue or abort the execution of the inference processing. The determination application may be referred to as a determination unit or a determination processing unit.

The inference application 303 executes the inference processing using the machine learning model managed by the inference model management unit 305. The inference application 303 displays the result of the inference processing on the display unit 208. Although the inference application 303 executes the inference processing in coordination with the inference execution unit 211, or using the inference execution unit 211, the inference application 303 may independently execute the inference processing by itself. The inference application may be referred to as an inference unit or an inference processing unit.

The setting management unit 304 manages setting information of the device 101, and also transmits and receives the setting information to and from each of the terminal 103, the device management server 104, and the device application server 105 via the network 100. Specific examples of the setting information will be described later.

The inference model management unit 305 executes processing for obtainment, transmission, updating, deletion, and the like of the machine learning model used by the inference application 303.

In FIG. 3B, a terminal application 310 is an application in the terminal 103 with a function of instructing the device 101 and the device application server 105 to execute an inference processing sequence, and a function of executing an inference processing sequence using the machine learning model obtained from the device 101. Furthermore, the terminal application 310 also has a function of transmitting and receiving information of the device 101 to and from the device management server 104. The terminal application 310 includes a communication unit 311, a determination application 312, the inference application 313, a device management application 314, a setting management unit 315, and an inference model management unit 316.

The communication unit 311 transmits and receives data to and from each of the device 101, the device management server 104, and the device application server 105 via the network 100.

In response to a user's request accepted by the operation unit 226, the determination application 312 determines which one of the device 101 and the device application server 105 is an optimal executor of the inference processing, and transmits an inference processing execution request to the inference application 313 or the inference application 332 of the device application server 105 in accordance with a determination result.

Upon receiving the inference processing execution request, the inference application 313 executes the inference processing using the machine learning model managed by the inference model management unit 316. The inference application 313 receives the inference processing execution request from the determination application 312, the determination application 302 of the device 101, or the like.

The device management application 314 registers and manages a device with which the terminal 103 communicates. Information related to the registered device (referred to as device information) is managed by the setting management unit 315. Furthermore, the application 314 transmits the device information managed by the management unit 315 to the later-described device management server 104, thereby sharing data.

The inference model management unit 316 makes a copy of the machine learning model managed by the inference model management unit 305 of the device registered with the device management application 314, and manages the copy. Normally, the machine learning model managed by the inference model management unit 316 is not used in the inference processing. The machine learning model managed by the management unit 316 is used in a case where the machine learning model held in the unowned device 102 is not desired to be used in the later-described inference processing in the device 102. The details of this inference processing will be described later.

In FIG. 3C, a device management server application 320 is an application with a function of executing a device management processing sequence in the device management server 104. The device management server application 320 includes a communication unit 321, an authentication application 322, a device management application 323, and a data management unit 324.

The communication unit 321 transmits and receives data to and from each of the devices 101 and 102, the terminal 103, and the device application server 105 via the network 100.

The authentication application 322 identifies an owner user of a device, and executes authentication and authorization processing. Owner user information of the device is saved and managed by the data management unit 324.

The device management application 323 registers and manages a user authenticated by the authentication application 322 and device information of an owned device of that user in association with each other. Note that in the present embodiment, processing for registering device information is expected to be executed upon receiving data from the device management application 314 of the terminal 103. However, device information may be registered directly with the device management server 104 via a web browser or a dedicated application.

The data management unit 324 saves and manages user information handled by the authentication application 322, device information handled by the device management application 323, and the like.

In FIG. 3D, a device service application 330 is an application in the device application server 105 with a function of executing inference processing for a corresponding device. The device service application 330 includes a communication unit 331, the inference application 332, a data management unit 333, and an inference model management unit 334.

The communication unit 331 transmits and receives data to and from each of the devices 101 and 102, the terminal 103, and the device management server 104 via the network 100.

Upon receiving a request from the determination application 302 of the device 101, the inference application 332 executes inference processing that is difficult to execute on the device. The inference processing that is difficult to execute on the device is, for example, inference processing that takes time to complete with a hardware performance of the device. In general, a hardware performance of the server 105 is often superior to that of the device 101.

The inference model management unit 334 executes processing for obtainment, updating, deletion, and the like of the machine learning model used by the inference application 332.

### Examples of Screen Display at the Time of Device Registration

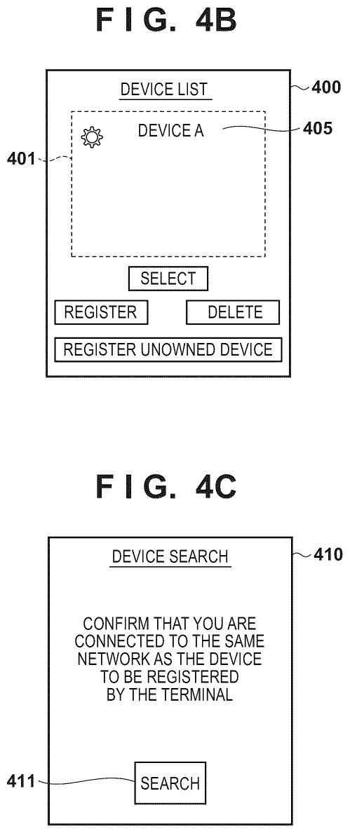

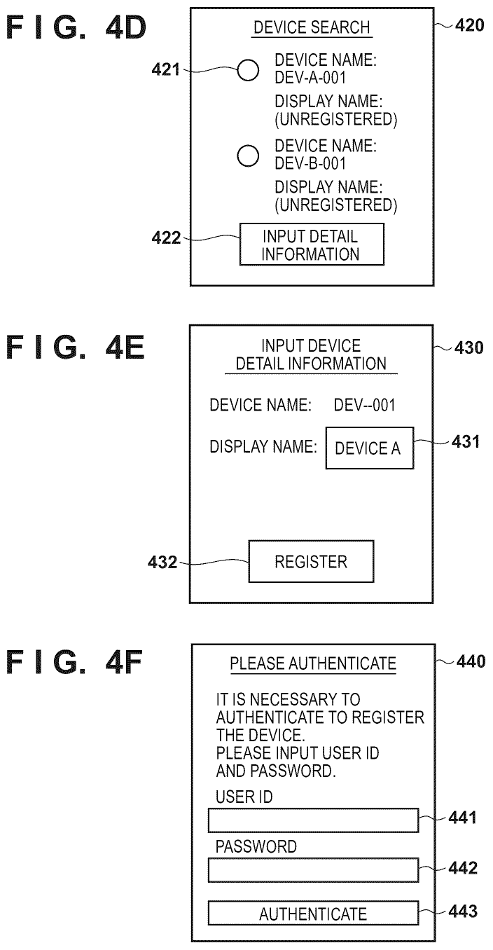

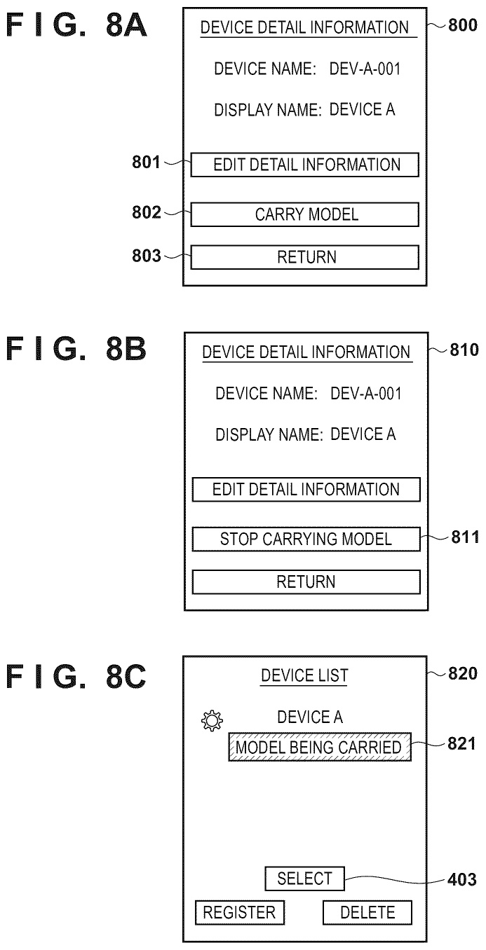

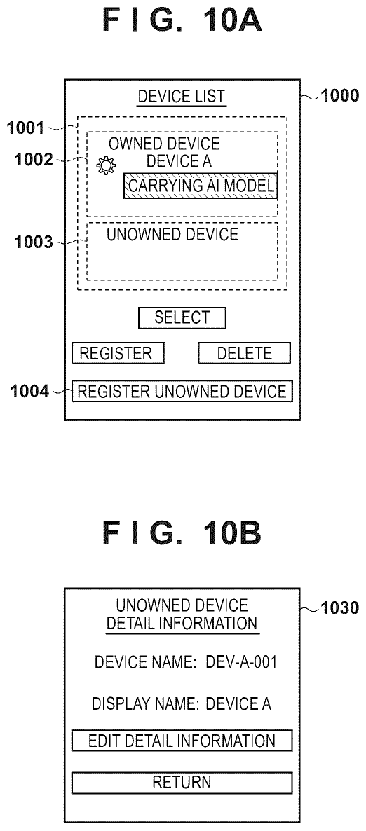

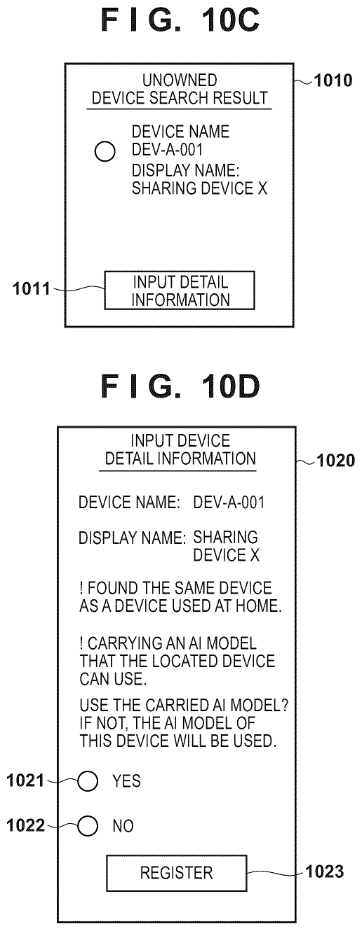

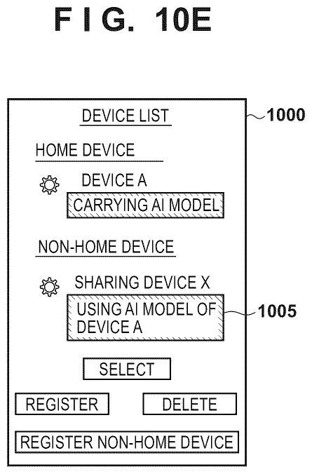

FIG. 4A-FIG. 4F are diagrams showing a flow of a sequence of screens that are displayed on the display unit 208 of the terminal 103 in device registration processing according to the present embodiment. Note that, here, a description is given of a device list screen, a device detail information screen, and a device detail information input screen that accompany device registration; holding and deletion of a machine learning model, registration of an unowned device, and the like will be described later with reference to screens of FIG. 8A-FIG. 8C, FIG. 10A-FIG. 10E, and the like.

In FIG. 4A, a device list screen 400 is a screen that displays a list of pieces of device information registered with the application 314. The device list screen 400 is displayed in response to, for example, an operation performed by an authenticated user on the terminal 103 to start or activate the terminal application 310 and select device registration or a device list from an operation menu, for example.

A device list display area 401 of the device list screen 400 displays a list of pieces of device information of devices that have been registered with the application 314. It displays a blank space in a state where no device information has been registered. Note that, although not shown in FIGS. 4A to 4F, the device list display area 401 is divided into a display area for owned devices and a display area for unowned devices, and registration of owned devices and registration of unowned devices can be performed therein, as will be described in detail using FIG. 10A-FIG. 10E. However, below, a description of operations and display screens for unowned devices is omitted, and operations and display screens at the time of registration of devices as owned devices will be described.

A device registration button 402 is a button for starting a sequence of device registration processing. When the button 402 has been pressed (or a tap operation or the like has been performed thereon), the device registration processing is started, and the screen transitions to a device search screen 410.

A device selection button 403 is a button for confirming a selection of desired device information from among the pieces of device information displayed in the device list display area 401. When the button 403 has been pressed in a state where one of the displayed pieces of device information has been selected, the screen transitions to a device detail information screen 430.

A device deletion button 404 is a button for deleting registered device information. When the button 404 has been pressed in a state where a piece of device information displayed in the device list display area 401 has been selected, the selected piece of device information is deleted from the registered pieces of device information. The deleted piece of device information is also erased from the device list display area 401.

An unowned device registration button 1004 is a button intended to search for a device and register the same as an unowned device of a user who has logged in the terminal 103. Registration of an unowned device will be described later with reference to FIG. 10A-FIG. 10E, and therefore a description thereof is omitted here.

In FIG. 4C, the device search screen 410 is a screen to which an instruction for searching for devices that are connectable via the network 100 can be input. When a search button 411 has been pressed, the device management application 314 transmits a search request to all devices connected to the network 100 via the communication unit 311. A device that has received the search request transmits device information of that device to the terminal 103 as a result of the search request (i.e., a search result).

In FIG. 4D, a device search result screen 420 is a screen displaying a list of the results of the search request that the application 314 has received from the network 100.

A search result display area 421 displays a list of pieces of device information included in the results of the search request. The present embodiment presents an example in which a list of model names (device names), which are fixed values for identifying devices, and display names that can be freely input by owner users of the devices via the application 314, is displayed in such a manner that the number of the model names and the display names correspond to the number of discovered devices, namely devices that have responded with the search results.

A detailed information input button 422 is a button for transitioning to the device detail information screen 430, which displays detailed information of a selected device. When the button 422 has been pressed in a state where a piece of device information displayed in the search result display area 421 has been selected, the screen transitions to the device detail information screen 430.

In FIG. 4E, the device detail information screen 430 is a screen to which an owner user of a device inputs additional information for comprehensible identification of device information to be registered with the device management application 314. Here, a display name is shown as an example of the additional information.

A display name input field 431 is a field to which information that is easily identified by the owner user, like information indicating what kind of device the device is, is input. It is possible to input information that facilitates the use of the device on the device management application 314, like information indicating who the owner of the device is. Note that although only the field 431 is shown in the present embodiment, there is no intention to limit the number thereof. For example, an input field for the location of placement of the device and the like may be displayed.

A device registration button 432 is a button for registering the piece of device information that is selected at that time, including a setting value input to the display name input field 431. Performing a tap operation on the device registration button 432 transitions to a user authentication screen 440 for registering the selected piece of device information.

In FIG. 4F, the user authentication screen 440 is a screen for executing authentication processing on the server 104 in order to specify a user with whom device information is to be associated.

A user ID input field 441 is a field to which a user ID is input. A password input field 442 is a field to which a password is input.

When the user has input the user ID and the password and pressed an authentication button 443, the application 314 transmits an authentication request to the server 104. When the authentication has succeeded, the device management application 314 registers the piece of device information with the setting management unit 315, and transitions to the device list screen 400.

When the device registration has succeeded, device information 405 is displayed in the device list display area 401 of the device list screen 400 as shown in FIG. 4B.

In the above-described manner, the user can search for devices from the terminal 103, selects a desired device from among the searched devices, and register the selected device with the terminal 103.

### Device Registration Processing

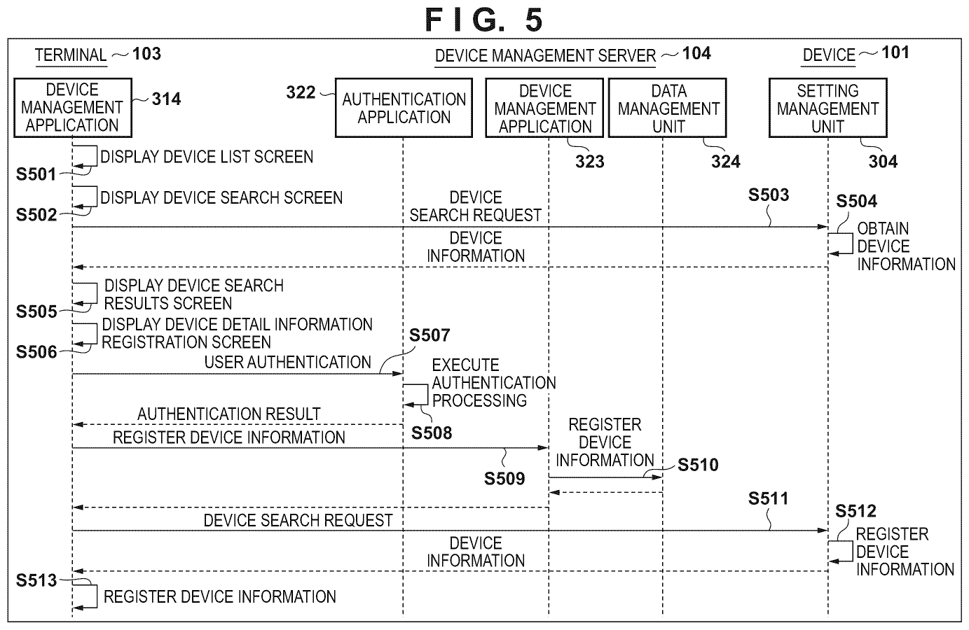

FIG. 5 is a sequence diagram showing a flow of a sequence of device registration processing related to the present embodiment. Apparatuses involved in the processing sequence of FIG. 5 are the terminal 103, the device management server 104, and the device 101, and processing on each apparatus is realized by the CPU of each apparatus executing a program. Although software modules of each apparatus are described as main executors with regard to FIG. 5, a main executor of hardware is the CPU of each apparatus that realizes these software modules by executing the program. Prior to the sequence of FIG. 5, a user has finished authentication and logged in the terminal 103 by inputting authentication information, including a user ID, thereto.

In step S501, the device management application 314 of the terminal 103 displays the device list screen 400 on the display unit 208 in response to an operation of selecting device registration or a device list from an operation menu, for example.

In step S502, when the registration button 402 of the device list screen 400 has been pressed, the device management application 314 displays the device search screen 410.

In step S503, when the search button 411 of the device search screen 410 has been pressed, the device management application 314 transmits a device search request to all devices connected to the network 100.

In step S504, upon receiving the device search request, the setting management unit 304 of the device 101 obtains device information, and transmits the same to the device management application 314.

Table 1 is a table showing an example of device information that the setting management unit 304 transmits to the device management application 314 as a search result in response to the search request.

TABLE 1
Search Result Table

| Serial | Model Name | IP Address |
|---|---|---|
| AAA | DEV-A-001 | XXX.XXX.XXX.XXX |

In Table 1, a serial column is a column that stores a serial number that has been assigned to uniquely identify a device. A model name column is a column that stores a model name indicating a type of the device. An IP address column is a column that stores an IP address of the device. In this way, the search result includes identification information, a model name, and address information, such as an IP address, of the device, among the obtained device information. Note that in a case where the device information included in the device has been updated and a user ID, a display name, and the like have been newly added, the device 101 may also include the user ID and the display name as a part of the device information, in addition to the content of Table 1, in responding to the terminal 103.

In step S505, the device management application 314 displays at least the model name, among the device search result information that has been received, on the device search screen 420.

When a device has been selected and the detailed information input button 422 has been pressed on the device search screen 420, the device management application 314 displays the device detail information screen 430, and accepts an input of additional device detail information, such as an input of a display name, with respect to the selected device in step S506.

When the registration button 432 of the device detail information screen 430 has been pressed, the device management application 314 displays the authentication screen 440 and accepts a user authentication in step S507. The device management application 314 transmits user authentication information input on the authentication screen 440 to the authentication application 322.

Table 2 is a table showing an example of authentication information that the device management application 314 transmits to the server 104.

TABLE 2
Authentication Information Table

| User ID | Password |
|---|---|
| UserA | XXXXXXXX |

In Table 2, a user ID column is a column that stores a user name; a value in the user ID input field 441 is stored therein. A password column is a column that stores a password; a value in the password input field 442 is stored therein.

In step S508, the authentication application 322 obtains the user authentication information received by the communication unit 321, and executes authentication processing.

When the authentication processing has succeeded, the device management application 314 transmits the device information of the device that has been selected in step S505 and the device detail information that has been additionally input in step S506 to the device management server 104 in step S509. The registered device information includes the device information shown in Table 1.

Table 3 is a table showing an example of device registration information that the device management application 314 transmits to the device management server 104.

TABLE 3
Device Registration Information Table

| | Model | Display | IP | User |
|---|---|---|---|---|
| Serial | Name | Name | Address | ID |
| AAA | DEV-A-001 | Device of A | XXX.XXX.XXX.XXX | UserA |

A serial column is a column that stores a serial number that has been assigned to uniquely identify a device, namely identification information. A model name column is a column that stores a model name indicating a type of the device. A display name column is a column that stores a value input to the field 431. An IP address column is a column that stores an IP address of the device. A user ID column is a column that stores a user ID of a user to be associated with the device. The user ID may be a user ID of a user who is currently logging in the terminal 103.

In step S510, the device management application 323 of the device management server 104 saves the device information received by the communication unit 321 in the data management unit 324.

In step S511, the device management application 314 transmits the device registration information that was transmitted to the device management server 104 in step S509 also to the device 101. The content thereof is as shown in Table 3.

In step S512, the setting management unit 304 of the device 101 saves (or registers) the received device registration information. In this way, the ID of the user who has performed the registration and the display name input by that user are newly saved in the device 101. Thereafter, the device registration information shown in Table 3 may be transmitted as device information in response to a device search request.

In step S513, the device management application 314 of the terminal 103 saves the device registration information that was transmitted to the device management server 104 in step S509 in the management unit 315.

Through the above-described processing, the user who has executed the device registration processing on the terminal 103 is registered with the device management server 104 as an owner of the device 101. That is to say, the user who has executed the device registration processing is registered with the server 104 in association with the device 101.

### Inference Processing by Owned Device or Device Application Server

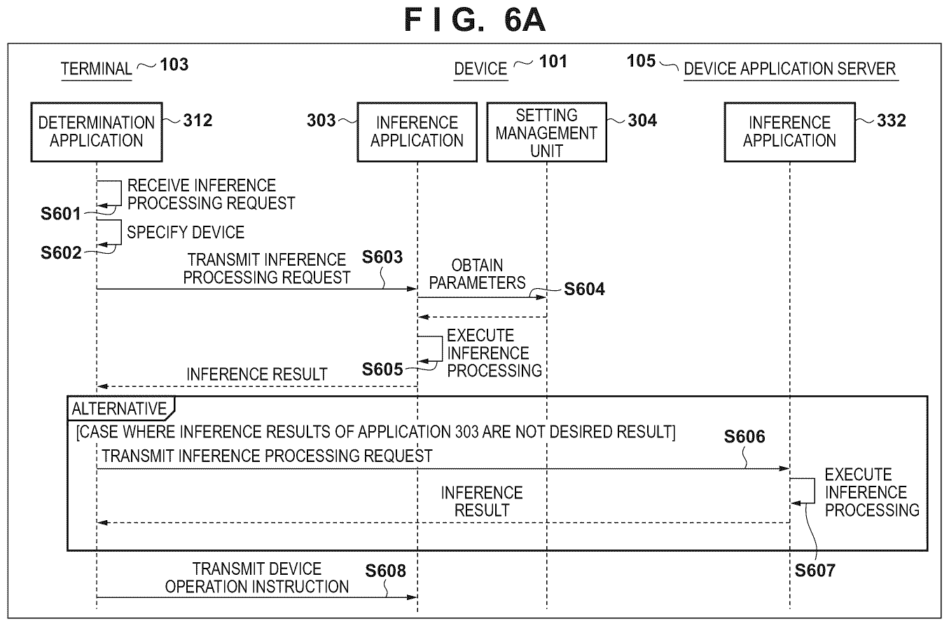

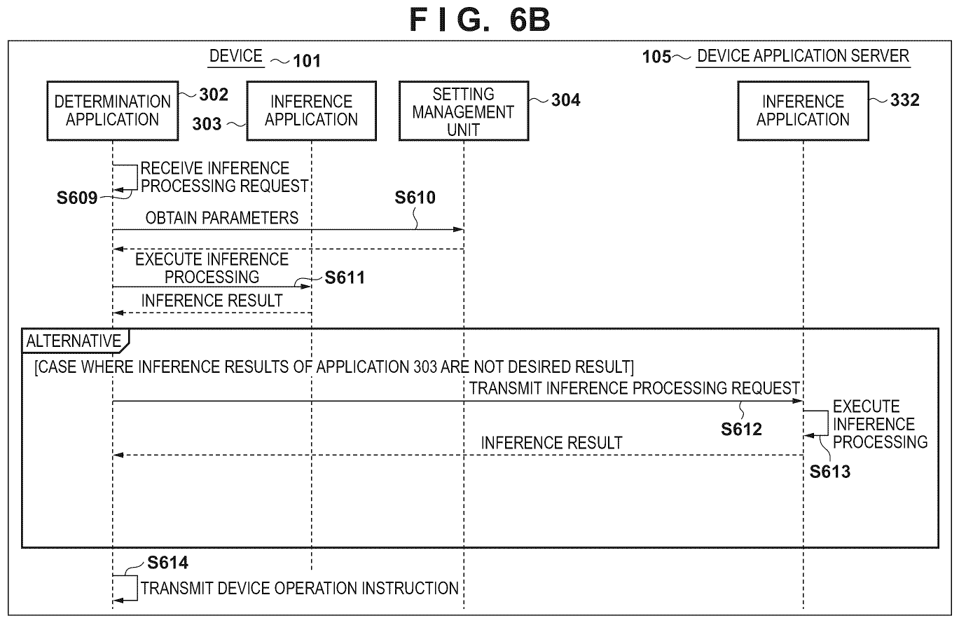

FIG. 6A and FIG. 6B are sequence diagrams showing a flow of a sequence of execution of the inference processing on the owned device 101 in the present embodiment. Note that FIG. 6A and FIG. 6B show a sequence for a case where the inference processing is executed by the device 101 or the device application server 105.

Apparatuses involved in the processing sequence of FIG. 6A are the terminal 103, the device application server 105, and the device 101, and apparatuses involved in the processing sequence of FIG. 6B are the device 101 and the device application server 105. Processing in each apparatus is realized by the CPU of each apparatus executing a program. Although software modules of each apparatus are described as main executors with regard to FIG. 6A and FIG. 6B, a main executor of hardware is the CPU of each apparatus that realizes these software modules by executing the program.

FIG. 6A is a sequence diagram showing a flow of a processing sequence for a case where, for example, a user has input an execution request for the inference processing from the inference application 313 of the terminal 103. A device on which the inference processing is executed may be specified prior to FIG. 6A. For example, processing of FIG. 6A may be executed in such cases as a case where a device to be used is designated and the inference processing by this device is also used. A device may be designated by, for example, selecting a device from the device list screen 400 displayed on the terminal 103.

In step S601, the determination application 312 of the terminal 103 receives an inference processing request from the user.

In step S602, the determination application 312 obtains information of the device 101 on which the inference processing is to be executed from a device registration information table of the setting management unit 315 of the terminal 103.

In step S603, the determination application 312 transmits the inference processing request to the inference application 303 of the device 101 based on the device information obtained in step S602. The inference processing request includes a parameter, such as a message input by the user, for example.

In step S604, the inference application 303 obtains information unique to the device 101 (device information) from the setting management unit 304.

In step S605, the inference application 303 executes the inference processing using the inference processing request received in step S603 and the device information obtained in step S604. The inference application 303 transmits an inference result to the determination application 312 of the terminal 103. The inference result received by the determination application 312 is displayed on the display unit 208 of the terminal 103.

Here, in a case where the displayed inference result is not a result desired by the user, the determination application 312 of the terminal 103 transmits an inference processing request to the inference application 332 of the device application server 105. This inference processing request may include a parameter (message) that is the same as the one transmitted in step S603. Whether the inference result is the result desired by the user may be decided based on a value input by the user with respect to the displayed inference result.

In step S607, the inference application 332 of the device application server 105 executes the inference processing, and transmits a result thereof to the application 312. The received inference result is displayed on the display unit 208 of the terminal 103, similarly to step S605.

In a case where the inference result derived by the inference application 303 of the device 101 or the inference application 332 of the device application server 105 is a result that should be desired by the user, the determination application 312 transmits a device operation instruction corresponding to the estimation result to the inference application 303 of the device 101 in step S608. The device operation instruction received by the inference application 303 of the device 101 is processed by the control unit 209. For example, as parameters, the inference result accepted by the user and the instruction therefor may accompany the device operation instruction. Upon receiving the device operation instruction, the device 101 may perform control in accordance with the parameters. For example, in a case where the device 101 is a microwave oven and the received parameters are a name of a dish and a temperature setting instruction, the device 101 may configure a temperature setting appropriate for the designated dish.

Through the above-described sequence, the device 101 is controlled based on the estimation result from the inference application of itself in accordance with an operation from the terminal 103. Furthermore, in a case where the estimation result from the inference application of the device 101 is not the result desired by the user, the device 101 is controlled based on the estimation result from the inference application provided by the server.

FIG. 6B is a sequence diagram showing a flow of a processing sequence for a case where an inference processing request has been input to the determination application 302 of the device 101. For example, an execution request for the inference processing may be input from the operation unit 206 of the device 101 by way of a user operation, or may be input from the network unit 204 or the like via communication. An input parameter (or a message) for the inference processing may also be input from the operation unit 206 of the device 101.

In step S609, the determination application 302 of the device 101 accepts an inference processing request from the user.

In step S610, the determination application 302 obtains information unique to the device 101 from the setting management unit 304.

In step S611, the determination application 302 passes the inference processing request received in step S609 and the device information obtained in step S610 to the inference application 303, and executes the inference processing. The determination application 302 displays an inference result derived by the application 303 on the display unit 208 of the device 101.

Here, in a case where the displayed inference result is not a result desired by the user, the application 302 transmits an inference processing request to the application 332 in step S612. Whether the inference result is the result desired by the user may be decided based on a value input by the user with respect to the displayed inference result.

In step S613, the application 332 executes the inference processing, and transmits a result thereof to the inference application 303 of the device application server 105. The inference application 303 transmits the inference result to the determination application 302 of the device 101. The determination application 302 displays the received inference result on the display unit 208 of the device 101, similarly to step S611.

In a case where the inference result derived by the inference application 303 or the inference application 332 is the result desired by the user, the application 302 executes a device operation instruction corresponding to the estimation result in step S614. The device operation instruction is processed by the control unit 209.

Through the above-described sequence, the device 101 is controlled based on the estimation result from the inference application of itself in accordance with an operation on the device 101. Furthermore, in a case where the estimation result from the inference application of the device 101 is not the result desired by the user, the device 101 is controlled based on the estimation result from the inference application provided by the server.

### Examples of Operations on Device Using Terminal 103

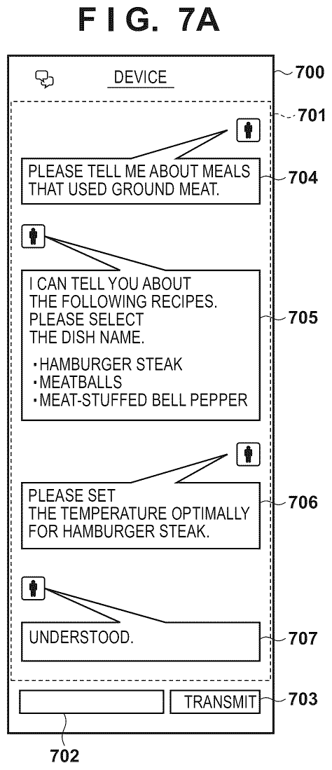

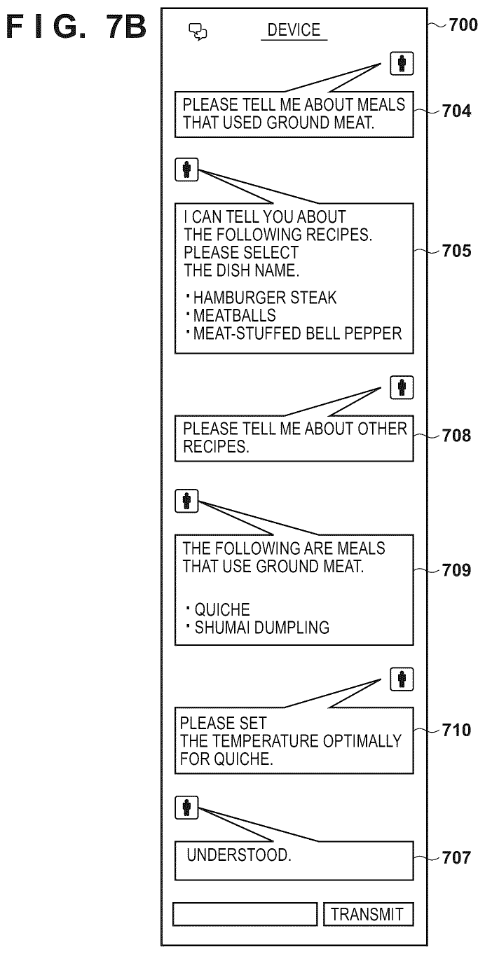

FIG. 7A and FIG. 7B are diagrams showing examples of screens that are displayed on the display unit 208 of the terminal 103 in the inference processing shown in FIG. 6A. Note that a description will be provided assuming that the device 101 is a microwave oven. Although the terminal 103 is assumed in the description, the screens shown in FIG. 7A and FIG. 7B may be displayed on the display unit 208 of the device 101 in accordance with the sequence of FIG. 6B. Furthermore, the screens of FIG. 7A and FIG. 7B are screens that are commonly displayed when using the device 101 or the device 102 from the terminal 103 in the present embodiment, regardless of what the main executor of the inference processing is.

FIG. 7A is a screen of the terminal 103 in a case where only the inference processing in the inference application 303 of the device 101 has been executed, specifically, in a case where steps S606 and S607 have not been executed, in processing from steps S601 to S608 shown in FIG. 6A. A part that cannot be displayed on the display unit 228 is displayed through a scroll operation and the like.

A determination application screen 700 is a screen that displays both of an inference processing request and an inference result in the execution of the inference processing. The screen 700 is a screen that the determination application 312 displays on the display unit 208.

A message display area 701 is an area that displays an inference processing request input from the user of the terminal 103, and an inference result received from the inference applications 303, 313, and 332 that are respectively in the device 101, the terminal 103, and the device application server 105, in the form of messages. Note that although the area 701 is presented in a mode of a general chat application in the present embodiment, there is no intention to limit the display mode thereof.

A message input field 702 is a field to which a response to the inference processing request and the inference result is input as a message.

A message transmission button 703 is a button that, when pressed, transmits the message input to the field 702 to the inference application 313.

Request message areas 704 and 706 are areas that display a message input to the field 701 by the user of the terminal 103. This message may be used as a parameter of an inference request.

The inference application 313 of the terminal 103 displays a result of the inference processing in a response message area 705 with respect to the message that has been input and displayed in the request message area 704. Specifically, the result of the inference executed by the inference application 303 or 332 is mainly displayed therein.

A response message area 707 displays a response to a message input to the area 706. Specifically, it displays the fact that an operation instruction has been transmitted to the device 101 in response to a user's instruction.

The sequence shown in FIG. 6A and the content displayed in the message display area 701 of FIG. 7A will be specifically described in association with each other.

First, when an inference processing execution request has been input to the message input field 702 and the message transmission button 703 has been pressed, step S601 is executed, and the request message area 704 including the input message is displayed.

When the determination application 312 of the terminal 103 has received an inference result from the inference application 303 of the device 101 in step S605, the content thereof is displayed in the response message area 705.

If the user of the terminal 103 is satisfied with the content of the inference result displayed in the response message area 705, the user inputs a device control instruction to the message input field 702 and presses the message transmission button 703. The content of the device control instruction is displayed in the request message area 706.

When step S608 has been executed, the determination application 312 displays a message indicating that the control instruction has been received in the response message area 707.

FIG. 7B is a screen of the terminal 103 in a case where the application 332 has executed processing of steps S601 to S608 shown in FIG. 6A as the inference processing, specifically, in a case where it has executed steps S601 to S608, including steps S606 and S607. In FIG. 7B, as a request message area 708 is similar to the request message area 704, a description thereof is omitted. As a response message area 709 is similar to the response message area 705, a description thereof is omitted. Similarly to the request message area 706, a request message area 710 displays a message that the user has provided while in agreement with an inference result, although the content of the displayed message is different.

The sequence shown in FIG. 6A and the content displayed in the message display area 701 will be specifically described in association with each other.

When an inference processing execution request has been additionally input to the message input field 702 and the message transmission button 703 has been pressed, step S606 is executed, and the request message area 708 is displayed.

When the determination application 312 has received an inference result from the inference application 332 in step S607, the content thereof is displayed in the response message area 709.

As described above using up to FIG. 7B, according to the system of the present embodiment, when using a device owned by a user, that is to say, registered in association with that owner, it is possible to use inference processing that uses a machine learning model provided in that device. Furthermore, it is also possible to use inference processing that uses a machine learning model included in a device application server in accordance with an instruction from the user. As it is possible to obtain an inference result using either inference processing and control the device accordingly, the user can use that device in a simpler and more appropriate manner.

Copying and holding Machine Learning Model of Device 101 by Terminal 103

The following describes a configuration in which the terminal 103 obtains a trained machine learning model from the device 101, holds the machine learning model obtained, and executes inference processing using the held machine learning model. Note that in the present embodiment, the device 101 includes the learning unit 212, and training of the machine learning model included in the device 101 can be advanced as the user uses the machine learning model. Therefore, it can be said that the machine learning model obtained by the terminal 103 is the latest machine learning model that reflects training on the device 101 at the time of the obtainment.

FIG. 8A-FIG. 8C are diagrams showing examples of screens when the machine learning model of the device 101 is copied and held by the terminal 103 in the present embodiment. Note that in FIG. 8A-FIG. 8C, the origin of transition is the device list screen 400 shown in FIG. 4A. Therefore, a description of overlapping screens and constituent elements thereof is omitted.

In FIG. 8A, device detail information screens 800 and 810 are screens to which the device list screen 400 transitions when the user has selected a device and pressed the selection button 403 thereon. Note that the selected device is an owned device, and is a device that has been selected from a display area for owned devices in the device list display area 401.

The device detail information screen 800 is a screen that is displayed in a case where the machine learning model of the device 101 selected on the device list screen 400 is not saved in the inference model management unit 316 of the terminal 103.

When the user has pressed a detail information editing button 801, a transition is made to the device detail information screen 430. When a model carriage button 802 has been pressed, the authentication screen 440 is displayed, and the user of the terminal 103 is requested to be authenticated. When the authentication processing has succeeded, the terminal 103 obtains the machine learning model stored in the inference model management unit 305 of the device 101. Note that although the authentication processing is executed in the present embodiment, it is not indispensable. Pressing a return button 803 will return to the device list screen 400.

In FIG. 8B, the device detail information screen 810 is a screen that is displayed in a case where the machine learning model of the device 101 selected on the device list screen 400 is saved in the inference model management unit 316 of the terminal 103. When a model carriage cancellation button 811 has been pressed, the machine learning model of the device 101 saved in the inference model management unit 316 of the terminal 103 is deleted.

In FIG. 8C, a device list screen 820 is an example of a device list screen that displays information of a device whose machine learning model is saved in the inference model management unit 316. In this example, a model carriage label 821 is displayed or not displayed on a per-device basis, in addition to a display name of a registered device. The model carriage label 821 is a label that is displayed additionally when information of a device whose machine learning model is saved in the inference model management unit 316 is displayed in the device list. The user of the terminal 103 can easily confirm whether the machine learning model has been held by the terminal 103 based on whether the label 821 is displayed. When a device for which the model carriage label 821 is displayed has been selected on the device list screen 820 and the selection button 403 has been pressed, the device detail information screen 810 is displayed. When a device for which the model carriage label 821 is not displayed has been selected on the device list screen 820 and the selection button 403 has been pressed, the device detail information screen 800 is displayed.

### Processing for Carrying Machine Learning Model of Device on Terminal

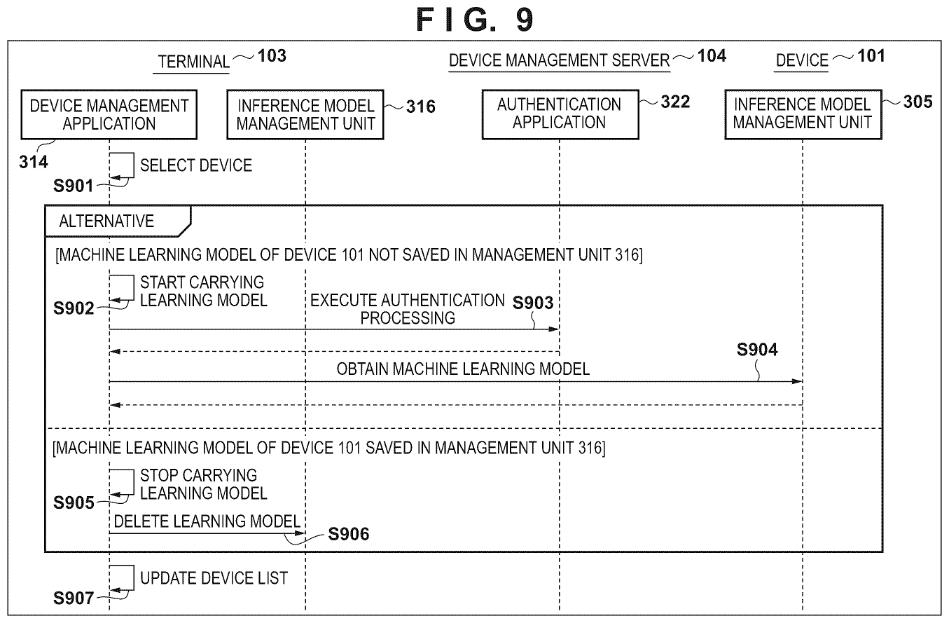

FIG. 9 is a sequence diagram showing a flow of a processing sequence for holding the machine learning model of the device 101 shown in FIG. 8A-FIG. 8C by the terminal 103. Apparatuses involved in the processing sequence of FIG. 9 are the terminal 103, the device management server 104, and the device 101. Processing in each apparatus is realized by the CPU of each apparatus executing a program. Although software modules of each apparatus are described as main executors with regard to FIG. 9, a main executor of hardware is the CPU of each apparatus that realizes these software modules by executing the program.

In step S901, the device management application 314 displays the device list screen 400 or 820 on the display unit 208. When the selection button 403 has been pressed in a state where target device information has been selected, the screen transitions to the device detail information screen 800 or the device detail information screen 810.

In a case where the machine learning model of the device 101 selected in step S901 is not saved in the inference model management unit 316, processing proceeds to step S902.

In step S902, the device management application 314 displays the device detail information screen 800 on the display unit 208. When then model carriage button 802 has been pressed, the device management application 314 transmits an authentication request to the authentication application 322 of the device management server 104 in step S903.

When the authentication processing has succeeded in the authentication application 322, the device management application 314 obtains the machine learning model from the inference model management unit 305 of the device 101, and saves the same in the inference model management unit 316 of the terminal 103 in step S904. The obtained machine learning model may be saved in association with information that can specify from which device the machine learning model has been obtained, such as device information of the device from which the machine learning model has been obtained (e.g., a serial number and a model name). The machine learning model saved in the inference model management unit 316 can be used for the inference processing by the inference application 313.

On the other hand, in a case where the machine learning model of the device 101 selected in step S901 is saved in the inference model management unit 316, the device detail information screen 810 is displayed on the terminal 103 in response to pressing of the selection button 403 on the device list screen 400 or 820, and processing proceeds to step S905.

In step S905, the device management application 314 displays the device detail information screen 810 on the display unit 208.

When the model carriage cancellation button 811 has been pressed, the device management application 314 deletes the machine learning model of the selected device 101 from the terminal 103, which is saved in the inference model management unit 316, in step S906.

In step S907, the device management application 314 displays latest information on the display unit 208, thereby updating the device list screen. The device detail information screen 810 is an example of display of device information on the terminal 103 in a case where the machine learning model has been obtained from the device 101 in the processing sequence from step S902 to step S904. The device information of the device whose machine learning model is saved in the inference model management unit 316 is displayed together with the model carriage label 821.

Through the above-described procedure, the terminal 103 can obtain a copy of the machine learning model of the device 101 registered in association with the user thereof. The obtained machine learning model can be used for the inference processing when using another device, for example.

### Unowned Device Registration Screen

FIG. 10A-FIG. 10E are diagrams showing a sequence of screens of device registration processing for using the machine learning model of the device 101 copied to the terminal 103 for inference processing on the unowned device 102. Note that there are many similarities between each of the screens in FIG. 10A-FIG. 10E and the device list screen shown in FIG. 4A in terms of elements and screen transitions. Therefore, overlapping descriptions are omitted, and only the elements and transitions that are unique to FIG. 10, which have not been provided in the descriptions of FIG. 4A and FIG. 8A-FIG. 8C, will be described.

In FIG. 10A, a device list screen 1000 is a screen that displays a list of pieces of device information registered with the device management application 314. Pieces of information of an owned device and an unowned device of a user who is currently logging in the terminal 103 are displayed together on the device list screen 1000.

A device information display area 1001 is a screen that displays pieces of device information saved in the setting management unit 315, and is composed of an owned device display area 1002 and an unowned device display area 1003.

The owned device display area 1002 is an area that displays device information registered by the owner of the terminal 103. Device information registered through the procedure shown in FIG. 4A-FIG. 4F and FIG. 5 is displayed in the owned device display area 1002.

The unowned device display area 1003 displays device information that has been registered by a user other than the owner of the terminal 103 similarly through the procedure shown in FIG. 4A-FIG. 4F and FIG. 5. Note that although the owned device display area 1002 and the unowned device display area 1003 are displayed separately inside the device information display area 1001 in the present embodiment, they need not necessarily be displayed separately. Although they are displayed separately in the present embodiment for easy understanding of the description, they may be displayed as a whole in the device information display area 1001. In this case, too, it is desirable that owned device information and unowned device information be displayed in a mode in which they can be distinguished from each other.

Registration processing for the unowned device 102, which is an unowned device, is started by pressing the unowned device registration button 1004. A device search screen that is displayed in response to pressing of the unowned device registration button 1004 is similar to the device search screen 410, and thus a description thereof is omitted. When the search button 411 has been pressed on the device search screen 410, a device detail information screen 1030 related to the unowned device is displayed.

In FIG. 10B, the device detail information screen 1030 for the unowned device is a screen to which the device list screen 400 or the device list screen 1000 transitions when the user has selected the unowned device and pressed the selection button thereon. The device detail information screen 1030 displays a device name and a display name, and also displays a detail information editing button and a return button. However, as the target is the unowned device, this screen does not include buttons related to holding and deletion of the machine learning model by a terminal, like those on the device detail information screens 800 and 810 of FIG. 8A and FIG. 8B targeted for the owned device. When the detail information editing button has been pressed on the device detail information screen 1030, the screen transitions to an unowned device detail information input screen 1020.

In FIG. 10C, an unowned device search result screen 1010 is a screen that displays the unowned device 102 that has been discovered as a result of search processing in response to pressing of the search button 411 on the device search screen 410. In the search for unowned devices, device search processing similar to FIG. 5 may be executed.

The difference between the search for unowned devices and the device search described using FIG. 4A-FIG. 4F and FIG. 5 is that, among the discovered devices, a device which is the same model as a device registered in association with a user who has logged in the terminal 103, and which is not registered in association with the user who has logged in, is a search result. That is to say, the device search result screen 1010 displays, among the obtained pieces of device information, only device information which has a model name that matches a value in a model name column of a device registered as an owned device in the device registration information table managed by the data management unit 324 of the device management server 104, and which has a user ID that does not match a user ID of the user who has logged in. This is the difference from the device search screen 420. Note, it is assumed that device information from a device associated with a user includes a user ID and a display name as shown in Table 4. However, in a case where device information does not include a user ID, among the obtained pieces of device information, device information which has a model name that matches a value in a model name column of a device registered as an owned device, and which includes a serial number that does not match any of registered devices, may be used as device information of an unowned device.

Note that in order to include a user name and a display name in device information transmitted from a device, it is necessary to refer to a device registration information table with which the device itself is registered. In view of this, a device that has received a device search request may request the device management server 104 for device information of this device managed by the device management server 104, and return the device information to a transmission source of the device search request if the device information has been returned. Alternatively, the terminal 103 that has received device information may make a request for and obtain device information of the pertinent device managed by the device management server 104 based on the received device information.

When a device has been selected on the unowned device search result screen 1010 and a detail information input button 1011 has been pressed, the screen transitions to the unowned device detail information input screen 1020 related to the selected device.

In FIG. 10D, the unowned device detail information input screen 1020 is a screen displayed when the device 101 of the same model as the selected unowned device 102 is registered with the setting management unit 315 of the terminal 103, and the machine learning model has been copied from the device 101 to the inference model management unit 316. The unowned device detail information device detail information input screen 1020 displays a model name and a display name of the selected device, and a message and options related to the use of the machine learning model held in the terminal 103.

Note that in a case where device information does not include a display name, a display name based on a user's input may be displayed; for example, a name obtained by appending a number and the like based on the number of registered unowned devices to a preset name (e.g., a shared device) may be displayed.

By operating the unowned device detail information input screen 1020, the user can select which one of the machine learning model copied from the device 101 and the machine learning model held in the unowned device 102 is to be used in the inference processing on the unowned device 102 to be registered.

When a carried model usage button (or “YES” button) 1021 has been selected, the machine learning model held in the inference model management unit 316 of the terminal 103 is used in the inference processing on the unowned device 102. When an unowned device model usage button (or “NO” button) 1022 has been selected, the machine learning model in the inference model management unit 305 of the unowned device 102 is used in the inference processing on the unowned device 102.

When a registration button 1023 has been pressed, the device management application 314 of the terminal 103 registers the device information of the unowned device 102 as unowned device information with the setting management unit 315, and transitions to the device list screen 1000.

The unowned device display area 1003 displays the registered unowned device, together with and a used model setting label 1005 indicating in which device the machine learning model that executes the inference processing is included (see FIG. 5E).

### Unowned Device Registration Processing

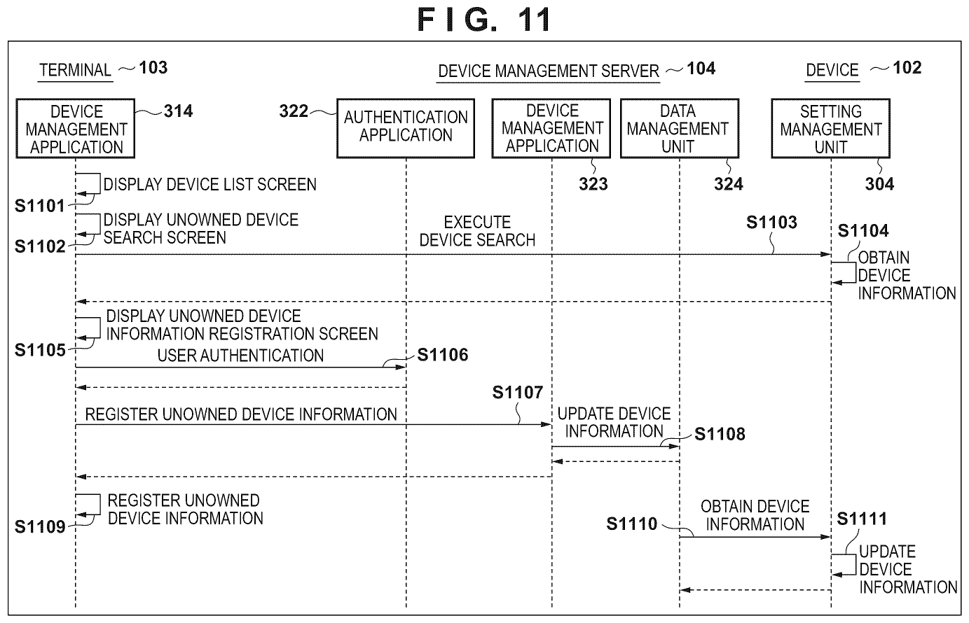

FIG. 11 is a sequence diagram showing a flow of a sequence of unowned device registration processing that is executed throughout the screens shown in FIG. 10A-FIG. 10E. Apparatuses involved in the processing sequence of FIG. 11 is the terminal 103, the device management server 104, and the unowned device 102. Processing in each apparatus is realized by the CPU of each apparatus executing a program. Although software modules of each apparatus are described as main executors with regard to FIG. 11, a main executor of hardware is the CPU of each apparatus that realizes these software modules by executing the program.

In step S1101, the device management application 314 of the terminal 103 displays the device list screen 1000 on the display unit 208.

When the unowned device registration button 1004 has been pressed on the device list screen 1000, the device management application 314 displays the device search screen 410 in step S1102.

When the search button 411 has been pressed on the device search screen 410, the device management application 314 transmits a device search request to devices connected to the network 100 via the communication unit 311 in step S1103.

In step S1104, the setting management unit 304 of the device 102 that has received the device search request obtains device registration information from the device registration information table, generates a device search response, and transmits the same to the device management application 314.

Table 4 is a table showing an example of a search result that the unowned device transmits to the communication unit 311 via the communication unit 301 as a response to the device search request.

TABLE 4
Search Result from Unowned Device

| | Model | Display | IP | User |
|---|---|---|---|---|
| Serial | Name | Name | Address | ID |
| BBB | DEV-A-001 | Shared | YYY.YYY.YYY.YYY | UserB |
| | | Device X | | |

A serial column is a column that stores a serial number assigned to uniquely identify a device. A model name column is a column that stores a model name indicating a type of the device. A display name column is a column that stores a value input to the field 431. An IP address column is a column that stores an IP address of the device. A user ID column is a column that stores a user ID of a user associated with the device.

As an unowned device is a device for which the device registration processing has already been executed by a different user, the search result additionally includes the display name column and the user ID column, unlike Table 1. Note that, as stated earlier, the terminal 103 may receive device information that does not include a user ID and a display name from the device 102, and obtain device information of this device registered with the device management server 104.

In step S1105, the device management application 314 displays a search result response received from the unowned device on the unowned device search result screen 1010. When the detail information input button 1011 has been pressed in a state where device information to be registered as an unowned device has been selected on the unowned device search result screen 1010, the device management application 314 displays the device detail information input screen 1020, and accepts an input of device detail information.

When the registration button 1023 has been pressed on the device detail information input screen 1020, the device management application 314 transitions to the authentication screen 440 and transmits an authentication request to the authentication application 322 in step S1106.

When an authentication success result has been received from the authentication application 322, the device management application 314 generates unowned device registration information from the device information of the unowned device selected on the unowned device search result screen 1010 in step S1105 and from the device detail information input on the device detail information input screen 1020, and transmits the same to the device management server 104 in step S1107.

Table 5 is a table showing an example of the unowned device registration information that the communication unit 311 of the terminal 103 transmits to the device management server 104.

TABLE 5
Unowned Device Registration Information Table

| Serial | Sharing User ID | Used Model |
|---|---|---|
| BBB | UserA | Terminal |

A serial column is a column that stores a serial number assigned to uniquely identify a device. A sharing user ID column is a column that stores an ID of a non-owner user who shares the use of the unowned device, which is a device already associated with a user. Note that in a case where a plurality of users have executed the unowned device registration processing, a plurality of user IDs are stored in the sharing user column.

The used model column is a column that stores information of a model that is used in the inference processing on the device by the user corresponding to a value of the sharing user ID column. When the carried model usage button 1021 has been selected on the device detail information input screen 1020, a value indicating that the machine learning model stored in the inference model management unit 316 of the terminal 103 is to be used, namely “terminal”, is input. In a case where the unowned device model usage button 1022 has been selected, a value “device” indicating that the machine learning model stored in the inference model management unit 305 of the device 102 is to be used is input.

In step S1108, when the device management application 323 of the device management server 104 has received the unowned device registration information, the data management unit 324 saves the received information in the unowned device registration information table.

Also, the data management unit 324 of the device management server 104 adds the value of the sharing ID column to a record of the device registration information with a value that matches the value in the serial column of the unowned device registration information.

Table 6 is a table showing an example of the device registration information that has been updated after the data management unit 324 of the device management server 104 has received the unowned device registration information.

TABLE 6
Device Registration Information Table

| | | | | | Sharing |
|---|---|---|---|---|---|
| | Model | Display | IP | User | User |
| Serial | Name | Name | Address | ID | ID |
| AAA | DEV- | Device | XXX.XXX.XXX.XXX | UserA | |
| | A-001 | of A | | | |
| BBB | DEV- | Shared | YYY.YYY.YYY.YYY | UserB | UserA |
| | A-001 | Device X | | | |

Basic elements are similar to those of Table 3. In addition, the value of the sharing user ID column of the unowned device registration information has been added to a record with a serial column of the unowned device registration information that matches a serial column of the device registration information managed in the device registration information table. The sharing user ID column is a column that stores a value of a user ID of the user who has registered this device as an unowned device.

In step S1109, the device management application 314 registers the unowned device registration information and updates the device registration information in the setting management unit 315, similarly to step S1108.

In step S1110, the setting management unit 304 of the device 102 requests the data management unit 324 of the device management server 104 for the device registration information of the device 102, and obtains the same.

In step S1111, the setting management unit 304 of the device 102 updates the device registration information held therein using the obtained device registration information.

Note that steps S1110 and S1111 may be, for example, executed by each device on a regular basis. Alternatively, when the device registration information has been updated, the device management server 104 may transmit the updated device registration information to a corresponding device and cause updating of the device registration information, instead of a voluntary update of the device registration information by the device 102. Furthermore, the terminal 103 may cause an update of the device registration information by transmitting especially the sharing user ID in the device registration information of the device 102 to the device 102 and requesting an update.

Through the above-described processing, the owner of the device 101 completes settings for using the machine learning model of the device 101 included in the terminal 103, instead of the machine learning model of the device 102, when using the inference function of the device 102 that is the same model as the device 101. Such settings enable the user of the terminal 103 to execute the inference processing using the machine learning model of the device 101 held by the terminal 103 when using the device 102, even if it is an unowned device. Furthermore, as identification information of a sharing user held in the unowned device can be updated, a sharer of the device can be specified from device registration information obtained from the device.

### Inference Processing on Unowned Device

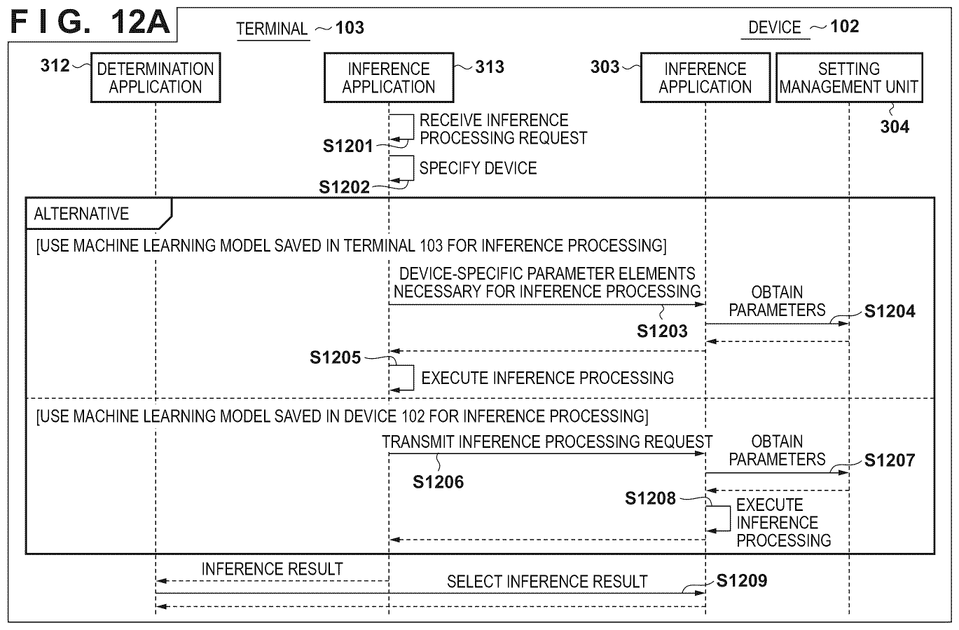

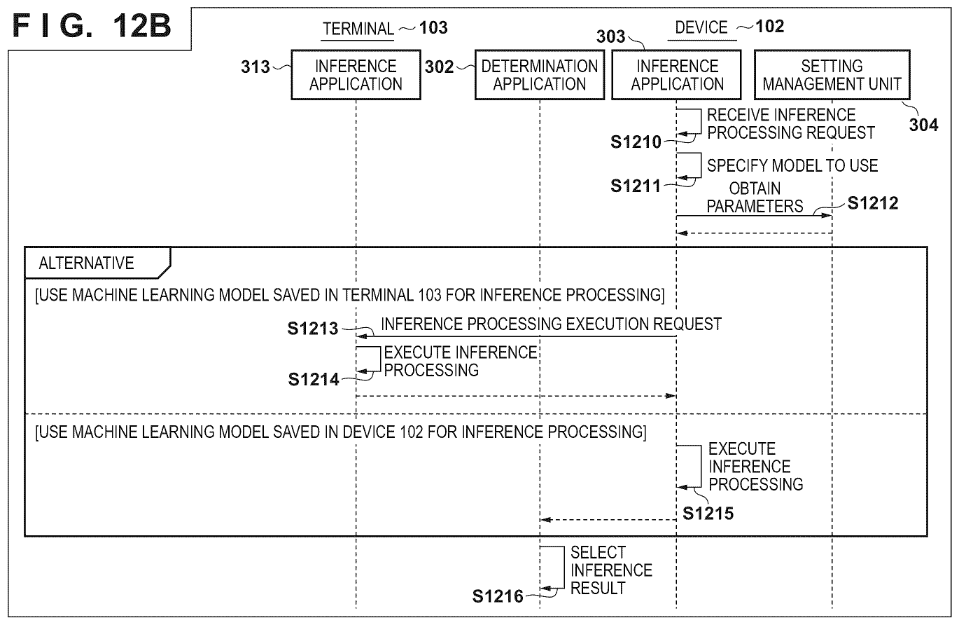

FIG. 12A and FIG. 12B are sequence diagrams showing flows of sequences of execution of the inference processing on the unowned device 102 in the present embodiment. Apparatuses involved in the processing sequences of FIG. 12A and FIG. 12B are the terminal 103 and the unowned device 102. Processing in each apparatus is realized by the CPU of each apparatus executing a program. Although software modules of each apparatus are described as main executors with regard to FIG. 12A and FIG. 12B, a main executor of hardware is the CPU of each apparatus that realizes these software modules by executing the program.

FIG. 12A is a sequence diagram showing a flow of a processing sequence for a case where an execution request for the inference processing has been input from the inference application 313 of the terminal 103. Note that FIG. 12A shows a case where the inference processing is executed once with respect to one input message; in a case where inputting of a message and the inference processing are executed repeatedly multiple times, steps S1203 to S1205 or steps S1206 to S1208 are executed repeatedly.

In step S1201, the inference application 313 accepts an inference processing request from a user. This inference request includes a message input to the message input field 702.

In step S1202, the inference application 313 obtains information of the device 102, on which the inference processing is to be executed, from the device registration information table of the setting management unit 315. Next, the inference application 313 obtains values of a serial column and a sharing user ID column of the obtained device registration information. Then, the inference application 313 obtains, from the unowned device registration information table, a record with values that respectively match the obtained values of the serial column and the sharing user ID column. With reference to a value of a used model column in the obtained record of the unowned device registration information, the inference application 313 judges which one of the machine learning models in the terminal 103 and the device 102 is to be used in the inference processing on the device 102.

In a case where the value of the used model column in the obtained record of the unowned device registration information is “terminal”, the machine learning model copied from the device 101, which is saved in the inference model management unit 316, is used in the inference processing. In this case, processing is executed from step S1203.

In step S1203, the inference application 313 transmits, to the inference application 303 of the device 102, an obtainment request for information unique to the device 102 that is necessary for the execution of the inference processing. The information unique to the device 102 denotes data that exists only in the device 102, such as device setting information saved in the setting management unit 304.

In step S1204, the inference application 303 of the device 102 obtains the device-unique information necessary for the inference processing from the management unit 304, and transmits the same to the inference application 313 of the terminal 103.

In step S1205, the inference application 313 executes the inference processing using the data obtained from the device 102 in step S1204, and the inference processing request accepted in step S1201.

In a case where the value of the used model column is “device”, the machine learning model saved in the inference model management unit 305 of the device 102 is used in the inference processing. Furthermore, also in a case where the record that matches both of the serial number of the device 102 and the ID of the user who is currently logging in the terminal 103 was not obtained from the unowned device registration information table in step S1202, the machine learning model saved in the inference model management unit 305 of the device 102 is used in the inference processing. That is to say, in cases other than the case where it has been determined to execute the inference processing using the machine learning model copied from the device 101, which is saved in the inference model management unit 316 of the terminal 103, the inference processing is executed using the machine learning model saved in the inference model management unit 305 of the device 102. In these cases, processing is executed from step S1206.

In step S1206, the inference application 313 of the terminal 103 transmits the inference processing request accepted in step S1201 to the inference application 303 of the device 102.

In step S1207, the inference application 303 of the device 102 obtains device-unique information necessary for the inference processing from the setting management unit 304.

In step S1208, the inference application 303 executes the inference processing while using the device-unique information obtained in step S1207 and the inference processing request received in step S1206 as input parameters, for example. Then, the inference application 303 transmits an inference result to the inference application 313 of the terminal 103.

In step S1209, the determination application 312 of the terminal 103 displays the inference result in the response message area 705 of the screen 700 displayed on the display unit 208.

In the above-described manner, in a case where the terminal 103 causes the unowned device 102 to execute the inference processing, the inference processing on the unowned device can be executed by using a machine learning model of a device that is owned by and originally used by a user in accordance with settings of the device 102. Therefore, a trained model that has been trained on the owned device can be used also on the unowned device, and an inference result that reflects training conducted by the user can be obtained even in a case where, for example, a device at a travel destination is used.

FIG. 12B is a sequence diagram showing a flow of a processing sequence for a case where an execution request for the inference processing has been input from the inference application 303 of the device 102. Note that FIG. 12B shows a case where the inference processing is executed once with respect to one input message; in a case where inputting of a message and the inference processing are executed repeatedly multiple times, steps S1213 and S1214 or step S1215 is executed repeatedly.

In step S1210, the inference application 303 accepts an inference processing request from a user. On the device 102, too, a message is input from the operation unit 206, and the inference processing request is accompanied by the input message, similarly to the terminal 103.

In step S1211, the inference application 303 obtains information of the device 102, on which the inference processing is to be executed, from the device registration information table of the setting management unit 304. Next, the inference application 303 obtains values of a serial column and a sharing user ID column of the obtained device registration information. Then, the inference application 303 obtains, from the unowned device registration information table, a record with values that respectively match the values of the serial column and the sharing user ID column. With reference to a value of a used model column in the obtained record of the unowned device registration information table, the inference application 303 judges which one of the machine learning models in the terminal 103 and the device 102 is to be used in the inference processing on the device 102.

In step S1212, the inference application 303 of the device 102 obtains device-unique information necessary for the inference processing from the setting management unit 304.

In a case where the value of the used model column is “terminal”, the machine learning model copied from the device 101, which is saved in the inference model management unit 316, is used in the inference processing. In this case, processing is executed from step S1213.

In step S1213, the inference application 303 of the device 102 transmits the device-unique information obtained in step S1212 and the inference processing request received in step S1210 to the inference application 313 of the terminal 103.

In step S1214, the application 313 executes the inference processing, and transmits a result thereof to the application 303.

On the other hand, in a case where the value of the used model column is “device”, the machine learning model saved in the management unit 305 is used in the inference processing. Furthermore, also in a case where the record that matches both of the serial number of the device 102 and the ID of the user who is currently logging in the terminal 103 was not obtained from the unowned device registration information table in step S1211, the machine learning model saved in the inference model management unit 305 of the device 102 is used in the inference processing. That is to say, in cases other than the case where it has been determined to execute the inference processing using the machine learning model copied from the device 101, which is saved in the inference model management unit 316 of the terminal 103, the inference processing is executed using the machine learning model saved in the inference model management unit 305 of the device 102. In these cases, processing is executed from step S1215.

In step S1215, the inference application 303 executes the inference processing.

In step S1216, the determination application 302 displays the inference result in the response message area 705 of the screen 700 displayed on the display unit 208.

In the above-described manner, also in a case where an inference processing request has been input directly to the device 102, the inference processing on the unowned device can be executed by using a machine learning model of a device that is owned by and originally used by a user.

Through the above-described processing sequence, by holding the machine learning model of the owned device 101 by the terminal 103 and using the same in the inference processing on the device 102 that is located at a travel destination and the like and belongs to a different owner, the user of the present system can receive an inference processing result adapted to the user as long as the devices are of the same model, even if their owners are different.

### Second Embodiment

The first embodiment is based on the precondition that the terminal 103 to which the machine learning model of the owned device 101 has been copied and the unowned device 102 are connected directly by the network. This enables the inference processing on the device 102 to use the machine learning model of the device 101 held in the terminal 103, and the user of the terminal 103 to obtain a result similar to an inference processing result on the device 101 also on the device 102.

However, even if there is merit in using the device 102 with a feeling that is the same as a feeling of using a device that is ordinarily used, connecting the terminal 103 to a network of a third party at a travel destination and the like may be avoided for the reason of security concerns.

The present embodiment presents a method for using the machine learning model of the device 101 held in the terminal 103 in the inference processing on the device 102 without connecting the terminal 103 and the device 102 directly to a network.

Registration Operation without Connecting to Unowned Device

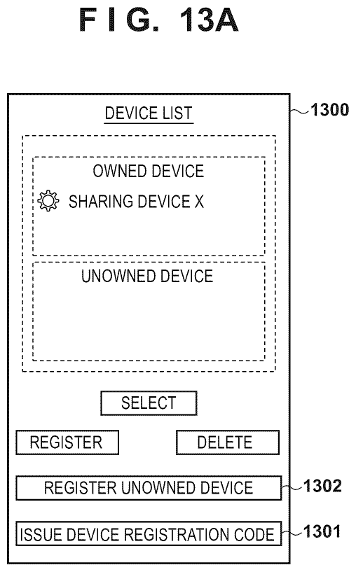

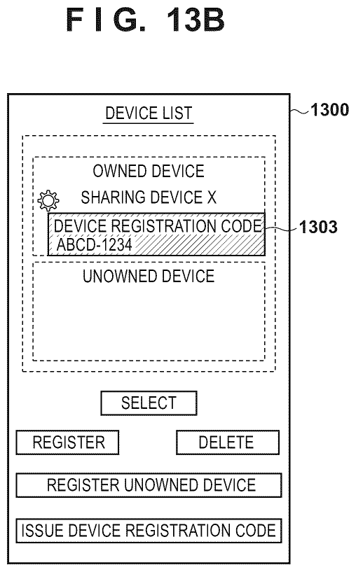

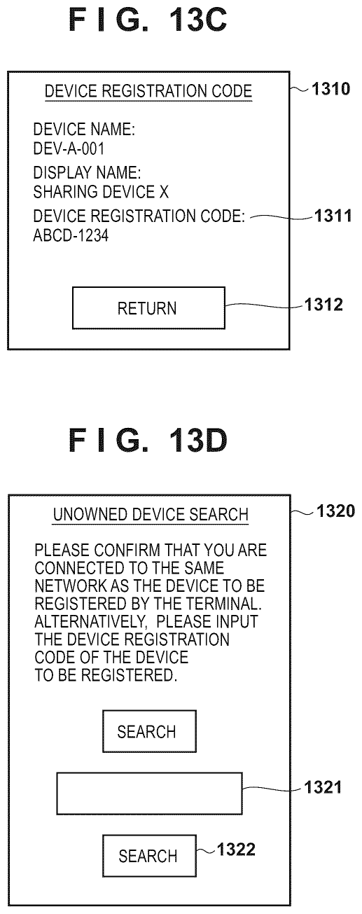

FIG. 13A to FIG. 13D are diagrams showing a sequence of screens displayed on the terminal 103 when registering the device 102 with the device management application 314 of the terminal 103 without connecting directly to a network in the present embodiment. Note that a description of elements that overlap with those of FIG. 4A-FIG. 4F and FIG. 10A-FIG. 10E is omitted.

FIG. 13A is a screen in the sequence for issuing a device registration code that is used when an owner of the device 102 registers the device 102 as an unowned device with respect to another user.

A device list screen 1300 is a screen that displays a list of pieces of device information registered with the device management application 314 in the present embodiment.

When a device registration code issuance button 1301 has been pressed in a state where device information has been selected, the device management application 314 displays an authentication screen 440, and makes a request for user authentication for accessing the device management server 104.

When the user authentication has succeeded, the device management application 314 receives a device registration code issued by the device management application 323 of the device management server 104, and displays a device registration code confirmation screen 1310 of FIG. 13C.

A device registration code display area 1311 of the device registration code confirmation screen 1310 is an area that displays the device registration code issued by the device management application 323 of the device management server 104.

Pressing a return button 1312 will return to the device list screen 1300.

In a case where there is device information for which the device registration code has been issued, the device management application 314 displays a device registration code label 1303 next to this device information inside the device list screen 1300 (see FIG. 13B). The device registration code label 1303 includes a display of the device registration code. Here, “the device information for which the device registration code has been issued” is device information that was selected when an instruction for issuance of the device issuance code was provided.

FIG. 13D is an unowned device registration screen 1320 that is intended for an owner of the device 101 to register the device 102 as an unowned device with the device management application 314 of the terminal 103 with use of the device registration code of the device 102.

When an unowned device registration button 1302 has been pressed in a state where the device management application 314 has displayed the device list screen 1300, the device management application 314 displays the unowned device registration screen 1320 shown in FIG. 13D.

A device registration code input field 1321 of the unowned device registration screen 1320 is a field that accepts an input of the device registration code. When the device registration code has been input to the device registration code input field 1321 and a registration button 1322 has been pressed, the device management application 314 executes registration of the unowned device.

Registration Processing Sequence without Connecting to Unowned Device

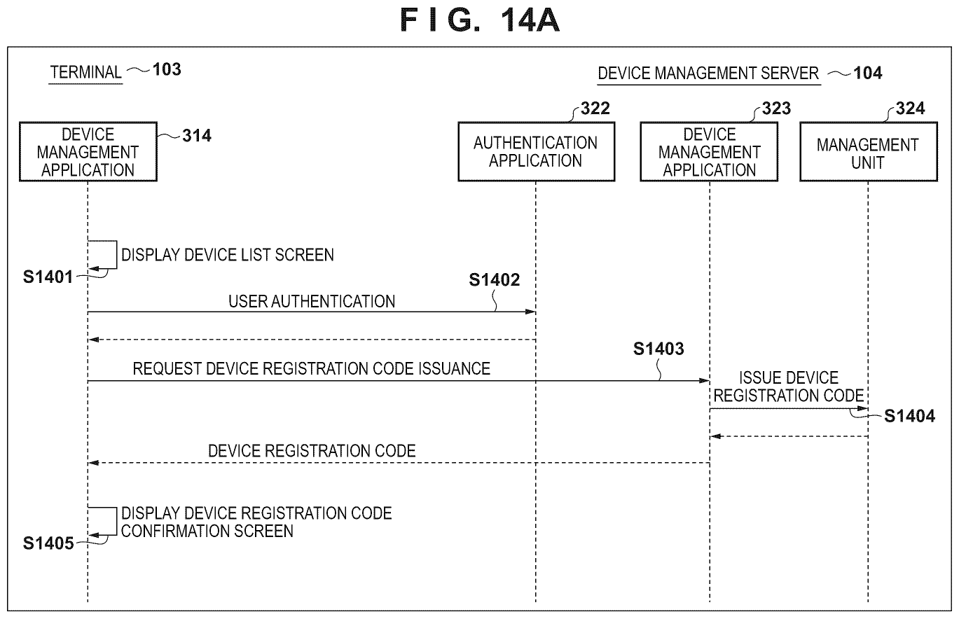

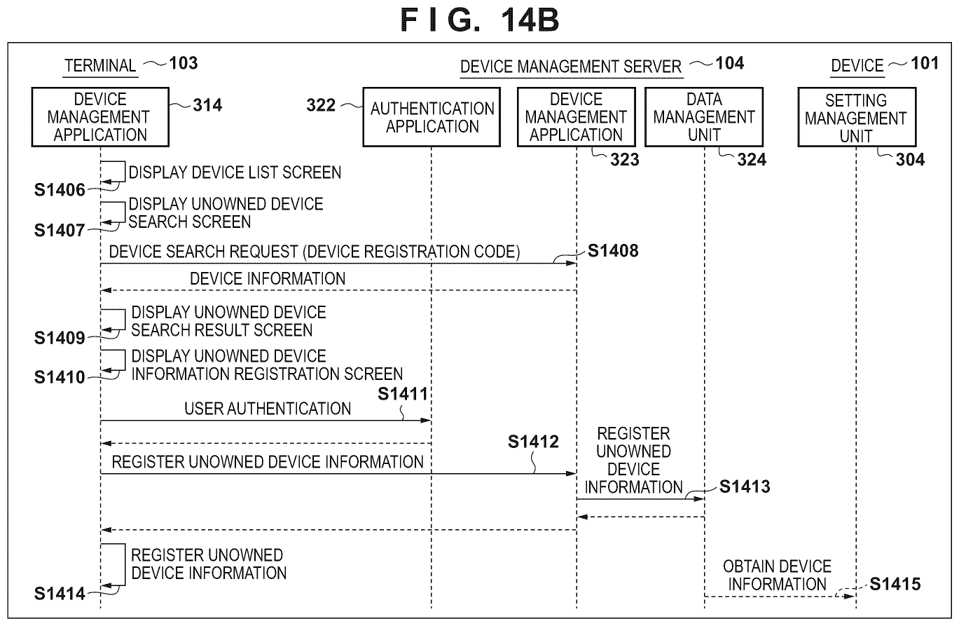

FIG. 14A and FIG. 14B are sequence diagrams showing procedures for registering the device 102 with the device management application 314 of the terminal 103 with use of the screens shown in FIG. 13A-FIG. 13D without connecting the device 102 directly to a network. Apparatuses involved in the processing sequences of FIG. 14A and FIG. 14B are the terminal 103, the device management server 104, and the device 101. Processing in each apparatus is realized by the CPU of each apparatus executing a program. Although software modules of each apparatus are described as main executors with regard to FIG. 14A and FIG. 14B, a main executor of hardware is the CPU of each apparatus that realizes these software modules by executing the program.

FIG. 14A is a sequence diagram showing a processing sequence in which an owner of the device 102 issues a device registration code with use of the screen shown in FIG. 13A. That is to say, an instructor of processing of FIG. 14A is the owner of the device 102. Also, the device 102 has already been registered by the owner thereof with the device registration information table held in the device management server 104.

In step S1401, the device management application 314 of the terminal 103 displays the device list screen 1300 in response to a user's operation.

When the device registration code issuance button 1301 has been pressed, the device management application 314 displays the authentication screen 440 in step S1402. When a user ID and a password have been input to the authentication screen 440, the application 314 transmits a user authentication request to the authentication application 322.

When an authentication success result has been received from the authentication application 322, the device management application 314 of the terminal 103 transmits a device registration code issuance request, together with a value of a serial column in the device registration information managed by the setting management unit 315, to the device management application 323 of the device management server 104.

In step S1404, the device management application 323 issues a device registration code. The device registration code has a unique value, and it is sufficient for this uniqueness to be unique within one model. That is to say, it is sufficient that the device registration code be unique on a per-model basis among devices managed as unowned devices that can be used by users other than the owner. The device management application 314 of the terminal 103 registers the issued device registration code with a record of the device registration information that matches the received value of the serial column in the device registration information table managed by the data management unit 324.

Table 7 is a table showing an example of a data structure of the device registration information table managed by the data management unit 324 of the device management server 104 in the present embodiment.

TABLE 7
Device Registration Information Table

| | | | | | | |
|---|---|---|---|---|---|---|
| | | | | | | Device |
| | Model | Display | | | Sharing | Registration |
| Serial | Name | Name | IP Address | User ID | User ID | Code |

| | | | | | |
|---|---|---|---|---|---|
| AAA | DEV- | Device of | XXX.XXX.XXX.XXX | UserA | |
| | A-001 | A | | | |
| BBB | DEV- | Shared | YYY.YYY.YYY.YYY | UserB | ABCD-1234 |
| | A-001 | Device X | | | |

As basic items of Table 7 are similar to those of Table 4, only the differences will be described. A device registration code column is a column that stores the device registration code issued by the device management application 323 in step S1404.

In step S1405, the device management application 314 of the terminal 103 displays the device registration code confirmation screen 1310, and displays the device registration code received from the device management application 323 in the device registration code display area 1311.

In the above-described manner, the device registration code can be provided to the unowned device 102 for the owner of the device 101, and registered with the device management server 104. A non-owner user who uses the device provided with the device registration code is informed of the device registration code, and the device 102 is registered as an unowned device with use of that code through the procedure of FIG. 14B.

FIG. 14B is a sequence diagram showing a processing sequence in which the owner of the device 101 registers the device 102 as an unowned device with use of the device registration code issued by the owner of the device 102. Note that no particular restriction is placed on a method of delivering the device registration code from the owner of the device 102 to the owner of the device 101. However, as it is a precondition that the device 102 and the terminal 103 do not belong to the same network, the terminal 103 accepts the device registration code either offline or using a method that does not involve access to the device 102. For example, the device registration code may be delivered directly using an electronic mail, or a sticker on which the device registration code has been printed may simply be attached to the device 102. An instructor of execution of processing of FIG. 14B is the owner of the device 101.

In step S1406, the device management application 314 of the terminal 103 displays the device list screen 1300 in response to an operation.

When the unowned device registration button 1302 has been pressed on the device list screen 1300, the device management application 314 displays the unowned device registration screen 1320 in step S1407.

In step S1408, when the registration button 1322 has been pressed in a state where the device registration code has been input to the device registration code input field 1321, the device management application 314 transmits the device registration code that has been input as a device search request to the device management application 323 of the device management server 104. With reference to the device registration information table managed by the data management unit 324, the device management application 323 obtains a record of the device information with a value in the device registration code column that matches the value of the received device registration code, and transmits this record to the device management application 314 of the terminal 103.

In step S1409, the device management application 314 displays the unowned device search result screen 1010, and displays the device information received in step S1408. The displayed items include a model name and a display name that has been set.

As processing from step S1410 to step S1414 is similar to processing from step S1105 to step S1109 of FIG. 11, a description thereof is omitted. In these steps, the unowned device registration information is registered with the unowned device registration information tables in the terminal 103 and the device management server 104.

Furthermore, also in the device registration information of the devices registered with the unowned device registration information table, a sharing user ID therein is updated.

Table 8 is a table showing an example of a data structure of the device registration information table after the device 102 has been registered as an unowned device for the owner of the device 101 in step S1413. The unowned device registration information table may be as shown in Table 5.

TABLE 8
Device Registration Information Table

| | | | | | | Device |
|---|---|---|---|---|---|---|
| | Model | Display | | User | Sharing | Registration |
| Serial | Name | Name | IP Address | ID | User ID | Code |
| AAA | DEV-A- | Device | XXX.XXX.XXX.XXX | UserA | | |
| | 001 | of A | | | | |
| BBB | DEV-A- | Shared | YYY.YYY.YYY.YYY | UserB | UserA | ABCD-1234 |
| | 001 | Device X | | | | |

The value of the user ID of the user of the terminal 103 that has been authenticated in step S1411 is stored as a value of a sharing user column. Note that as a result of step S1413, the updated device registration information is transmitted to the terminal 103 and registered with the management unit 315.

In step S1415, the setting management unit 304 of the device 101 transmits a serial number of the device 101 to the device management application 323 of the device management server 104, obtains the latest device information of itself managed by the data management unit 324, and updates the device registration information table held in the setting management unit 315 with use of this information. Step S1415 may be executed on a regular basis, for example.

Through the above-described processing sequence, the terminal 103 can register the device 102 as an unowned device with use of the device registration code of the device 102 without connecting directly to the device 102 via a network.

### Inference Processing on Unowned Device

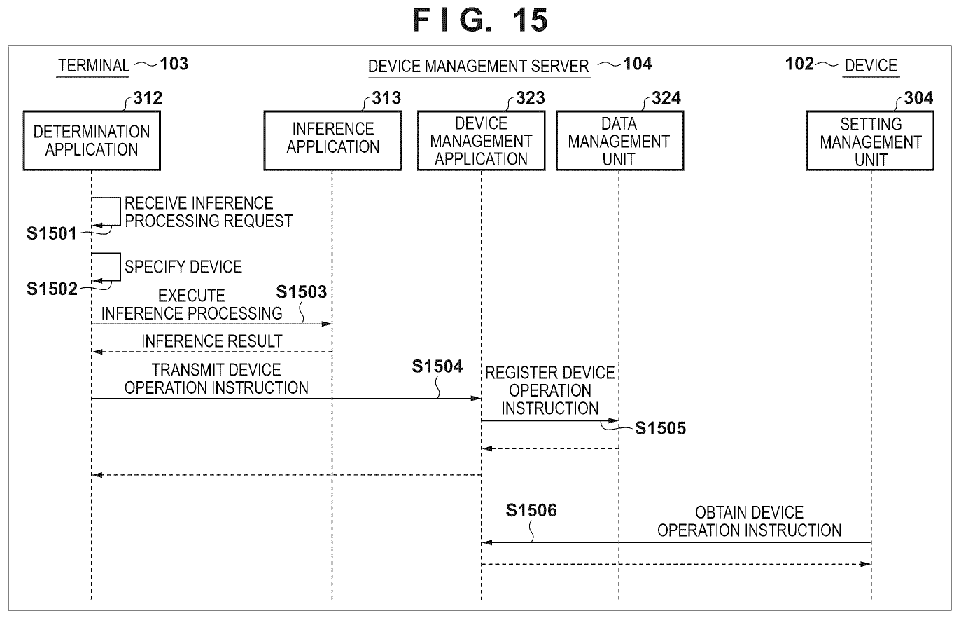

FIG. 15 is a sequence diagram showing a flow of a sequence of execution of the inference processing without connecting directly to the device 102, which has been registered as an unowned device with the terminal 103 through the unowned device registration processing shown in FIGS. 14A and 14B, via a network.

In step S1501, the determination application 312 receives an inference processing request from a user of the terminal 103 in response to an operation. Note, in the operation at this time, the unowned device 102 is selected, and the operation is performed with respect to the same.

In step S1502, the determination application 312 obtains device information of the device 102, which is the operation target, saved in the setting management unit 315.

In step S1503, the inference application 313 executes the inference processing using the machine learning model, which is saved in the inference model management unit 316, of the device 101 whose user is a sharing user of the device 102 and whose model is the same as the device 102. As the machine learning model is saved in association with information that can specify a device in which it has been held, the user and the model thereof can be specified from the device information.

In step S1504, the determination application 312 displays an inference result on the operation screen 700, and receives a device operation instruction based on the inference result from the user of the terminal 103. Then, the determination application 312 of the terminal 103 transmits the device operation instruction to the device management application 323 of the device management server 104.

Table 9 is a table showing an example of a data structure of the device operation instruction.

TABLE 9
Device Operation Instruction

| | | Content of Operation |
|---|---|---|
| Serial | User ID | Instruction |
| BBB | UserA | Configure Temperature |
| | | Setting Necessary to |
| | | Cook Hamburg Steak |

A serial column stores a value of a serial of a device for which the device operation instruction is to be executed. It stores a value of a serial column in the record of the device 102 in the device registration information table of Table 8. A user ID column is a column that stores a user ID of a user who has transmitted the device operation instruction. It stores a value of sharing user ID column in the record of the device 102 in the device registration information table of Table 8. An operation instruction content column is a column that stores a value of the device operation instruction that has been input to the operation screen 700 in step S1504.

In step S1505, the device management application 323 obtains a record with a value in a serial column of the received device operation instruction record that matches a serial column of the device registration information table saved in the data management unit 324. Then, the device management application 323 determines whether a value of a user ID column in the received device operation instruction record is included in a sharing user ID column of the device registration information record. In a case where the value is included, the device management application 323 saves the device operation instruction in the data management unit 324.

In step S1506, the setting management unit 304 of the device 102 obtains, from the device management application 323 of the device management server 104, a device operation instruction record with a value of a serial column that matches a serial of itself in the device operation instruction table saved in the data management unit 324 of the device management server 104. Note that the device 102 executes step S1506 asynchronously on a regular basis. The device 102 that has obtained the operation instruction record controls the device in accordance with the corresponding operation instruction.

In the above-described manner, the device 102 can indirectly receive a device operation instruction input from a user via the inference processing on the terminal 103 by way of the device management server 104 without connecting directly to the terminal 103 via a network.

### Third Embodiment

In the first and second embodiments, the terminal 103 stores the machine learning model copied from the device 101 in the inference model management unit 316, and uses the same in the inference processing. The data size of the machine learning model varies depending on the type of the device 101 and the scale of the inference processing to be executed. However, if the machine learning model is continuously saved, there is a possibility that the storage area of the external storage apparatus 203 of the terminal 103 is suppressed, thereby influencing other applications operating on the terminal 103.

The present embodiment will be described in relation to a method of automatically deleting the machine learning model copied to the terminal 103 from the inference model management unit 316 at a timing when this machine learning model becomes unnecessary. Note that the present embodiment is implemented in combination with the first or second embodiment.

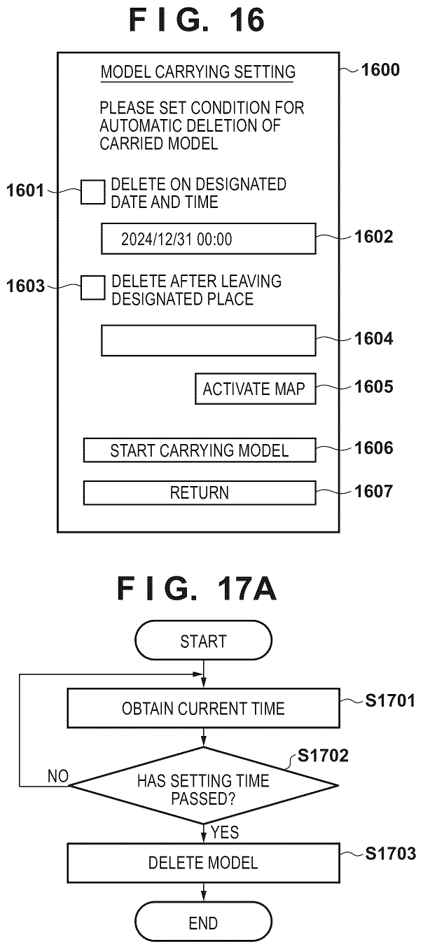

FIG. 16 is a diagram showing an example of a machine learning model carriage setting screen in the present embodiment. In the present embodiment, when the model carriage button 802 has been pressed on the device detail information screen 800, a machine learning model carriage setting screen 1600 is displayed.

By selecting a date/time setting checkbox 1601, a user of the terminal 103 can set, in a date/time setting input field 1602, the date/time to delete the machine learning model that has been copied from the device 101 and held. By selecting a location setting checkbox 1603, the user of the terminal 103 can set, in a location setting input field 1604, a reference position indicating that the machine learning model copied from the device 101 is deleted at a time point when the terminal 103 is distanced from this reference position by a certain distance. Note that position coordinates may be input directly to the location setting input field 1604. For example, in a case where a map application that uses the GPS 213 is installed in the terminal 103, position coordinates of the reference position may be input by, for example, touching a desired position or the like via the map application that has been started by pressing a map start button 1605. It is assumed that the reference position input to the location setting input field 1604 is a location at which the device 102 is placed.

As a return button 1607 is similar to the return button 803, a description thereof is omitted.

When a model carriage button 1606 has been pressed, the device management application 314 obtains a copy of the machine learning model from the device 101 through the procedure described using FIG. 9, and saves the copy in the inference model management unit 316. In addition, a model carriage setting that has been set on the model carriage setting screen 1600 is saved in the setting management unit 315.

Table 10 is a table showing an example of a data structure of the device carriage setting.

TABLE 10
Model Carriage Setting

| Date/Time | Location | Arrival |
|---|---|---|
| Setting | Setting | Flag |
| 2024/12/31 00:00 | XXX | FALSE |

A date/time setting column is a column that stores the value of the date/time of deletion of the model input to the date/time setting input field 1602. A location setting column is a column that stores position information of the reference position, which has been input to the location setting input field 1604 and which indicates that the model is deleted at a time point when the terminal 103 is distanced from this reference position by a certain distance. An arrival flag column is a column that stores a value indicating whether the location indicated by the value of the location setting column has already been reached. In a case where the value is FALSE, it indicates that the location has not been reached yet. In a case where the value is TRUE, it indicates that the location has already been reached.

### Processing for Deleting Machine Learning Model

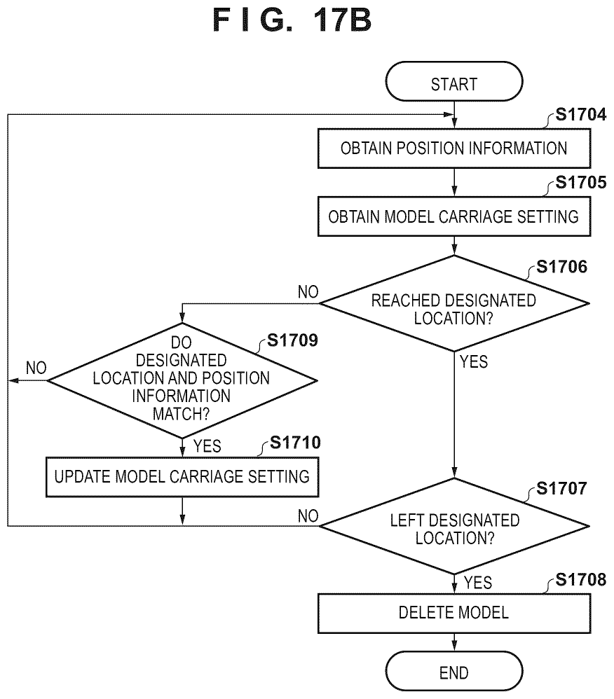

FIG. 17A and FIG. 17B are flowcharts showing a processing sequence for deleting the machine learning model saved in the management unit 316 of the terminal 103 based on the model carriage setting that has been set on the screen 1600. Note that the model deletion processing shown in FIG. 17A and FIG. 17B is processing that is executed by the device management application 314 of the terminal 103 asynchronously on a regular basis.

That is to say, processing of FIG. 17A and FIG. 17B is processing that is executed by the CPU 220 of the terminal 103 acting as a main executor.

FIG. 17A is a flowchart showing a processing sequence in which the application 314 deletes the machine learning model based on the value of the date/time setting column shown in Table 10.

In step S1701, the device management application 314 obtains a current time.

In step S1702, the device management application 314 obtains the value of the date/time setting column of the model carriage setting saved in the setting management unit 315, and determines whether the current time obtained in step S1701 has passed the value of the date/time setting column.

In a case where the current time has passed the value of the date/time setting column, the device management application 314 deletes the machine learning model from the inference model management unit 316 in step S1703.

In a case where the current time has not passed the value of the date/time setting column, processing returns to step S1701.

FIG. 17B is a flowchart showing a processing sequence in which the device management application 314 deletes the machine learning model based on the value of the location setting column shown in Table 10.

In step S1704, the device management application 314 obtains position information of the GPS 213.

In step S1705, the device management application 314 obtains the model carriage setting from the management unit 315.

In step S1706, the device management application 314 confirms the value of the arrival flag column. In a case where the value of the arrival flag column is TRUE, that is to say, when the set location has already been reached, processing proceeds to step S1707.

In step S1707, the device management application 314 calculates a distance between the position information obtained in step S1704 and the value of the location setting column obtained in step S1705. In a case where the calculated distance is larger than a certain value, that is to say, in a case where the terminal 103 has become distanced from the reference position by a predetermined distance after arriving the reference position, processing proceeds to step S1708. In step S1708, the device management application 314 deletes the machine learning model from the inference model management unit 316.

On the other hand, in a case where the value of the arrival flag column is not TRUE, that is to say, in a case where the set location has not been reached yet in step S1706, processing proceeds to step S1709.

In step S1709, in a case where the position information obtained in step S1704 matches the value of the location setting column obtained in step S1705, the value of the arrival flag column is updated to TRUE in step S1710. Note, here, they do not necessarily match each other precisely; a predetermined error may be tolerated.

With the above-described configuration and procedure, the machine learning model of the device 101 that has been copied to and held by the terminal 103 can be automatically deleted from the terminal 103 at a time beyond a designated time, or when the terminal 103 has become distanced from a designated location by a predetermined distance.

Also, the above-described deletion conditions may be combined. That is to say, the machine learning model of the device 101 held in the terminal 103 may be deleted if one of the following conditions has been satisfied: a designated time has arrived; and the terminal 103 has become distanced from the reference position by a predetermined distance after arriving at the reference position.

Note that it is possible to allow a distance to be designated, together with the coordinates of the reference position, on the model carriage setting screen 1600 of FIG. 16. In this case, the machine learning model of the device 101 held in the terminal 103 is deleted when the terminal 103 has become distanced from the reference position by the designated distance.

Furthermore, the machine learning model of the device 101 held in the terminal 103 may be deleted in a case where a predetermined period or a designated period has elapsed since the reference position has been reached, instead of a case where the terminal 103 has become distanced from the reference position by a predetermined distance or a designated distance after arriving at the reference position.

### Modification Examples

In the above-described first to third embodiments, as the terminal 103 also includes the learning unit 232, training can be advanced also on the terminal 103 in a case where the machine learning model of the device 101 held by the terminal 103 has been used. In view of this, parameters at the time of training on the terminal 103 may be saved and transmitted to the learning unit 212 of the device 101, and the machine learning model included in the device 101 may be trained accordingly. In this way, the result of training performed on the terminal 103 can be reflected in the machine learning model of the device 101 while leaving the result of training of the machine learning model on the device 101 after the machine learning model of the device 101 has been held by the terminal 103.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-173481, filed Oct. 2, 2024 which is hereby incorporated by reference herein in its entirety.

What is claimed is:

1. An information processing apparatus, comprising:
a communication unit;
at least one memory storing instructions; and
at least one processor that is in communication with the at least one memory and that, when executing the instructions, cooperates with the at least one memory to execute processing, the processing including
obtaining a copy of a first machine learning model from a first device that is connected via the communication unit, includes the first machine learning model, and is controlled based on a result of inference processing by the first machine learning model,
holding the obtained copy of the first machine learning model in the at least one memory, and
executing, in response to a request for inference processing for a second device, the inference processing that uses the copy of the first machine learning model held in the at least one memory.

2. The information processing apparatus according to claim 1, wherein
in the inference processing for the second device, the inference processing that uses the copy of the first machine learning model is executed using information unique to the second device obtained from the second device.

3. The information processing apparatus according to claim 1, further comprising
an input unit that accepts an input performed by a user,
wherein the request for the inference processing for the second device is based on the input performed by the user via the input unit.

4. The information processing apparatus according to claim 1, wherein
the request for the inference processing for the second device is based on a request from the second device received via the communication unit.

5. The information processing apparatus according to claim 1, further comprising
an output unit for an output to a user,
wherein
the processing includes registering the first device, and outputting information of the registered first device from the output unit, and
the information of the first device includes information indicating that the copy of the first machine learning model is held by the at least one memory.

6. The information processing apparatus according to claim 1, wherein
the second device is a device which is registered in correspondence with a second user and which is the same model as the first device, the second user being different from a first user who is registered in association with the first device, and
the second device is registered also in association with the first user as a device that can be used by the first user.

7. The information processing apparatus according to claim 1, wherein
the processing includes configuring a setting to use a second machine learning model included in the second device, or to use the copy of the first machine learning model held by the at least one memory, with respect to the second device, and
in a case where the setting has been configured to use the second machine learning model included in the second device, the second device executes inference processing that uses the second machine learning model in response to the request for the inference processing for the second device.

8. The information processing apparatus according to claim 6, wherein
the processing includes registering a device that has been selected from among devices connected via the communication unit as the second device.

9. The information processing apparatus according to claim 6, wherein
the processing includes receiving a device registration code that has been issued by a server connected via the communication unit in association with information of the second device, receiving the information of the second device associated with the accepted device registration code from the server, and registering the second device as a device that can be used by the first user.

10. The information processing apparatus according to claim 1, wherein
the processing includes deleting the copy of the first machine learning model held by the at least one memory.

11. The information processing apparatus according to claim 10, wherein
the copy of the first machine learning model is deleted from the memory in accordance with an instruction from a user.

12. The information processing apparatus according to claim 10, wherein
the copy of the first machine learning model is deleted from the at least one memory at a designated time.

13. The information processing apparatus according to claim 10, further comprising
a positioning unit,
wherein the copy of the first machine learning model is deleted from the at least one memory when a position measured by the positioning unit has become distanced from a designated position by a predetermined distance.

14. An inference system, comprising:
a first device that includes a first machine learning model and is capable of executing inference processing using the first machine learning model;
a second device that includes a second machine learning model and is capable of executing inference processing using the second machine learning model; and
an information processing apparatus,
wherein
the information processing apparatus includes:
a communication unit;
at least one memory storing instructions; and
at least one processor that is in communication with the at least one memory and that, when executing the instructions, cooperates with the at least one memory to execute processing, the processing including
obtaining a copy of the first machine learning model from the first device connected via the communication unit,
holding the obtained copy of the first machine learning model in the at least one memory, and
in a case where a setting has been configured to use the copy of the first machine learning model for a request for inference processing for the second device, executing, in response to the request for the inference processing for the second device, the inference processing that uses the copy of the first machine learning model held in the at least one memory.

15. A non-transitory computer-readable storage medium that stores a program for causing a computer to execute processing when loaded in and executed by the computer, the processing comprising:
obtaining a copy of a first machine learning model from a first device that is connected via a communication unit, includes the first machine learning model, and is controlled based on a result of inference processing by the first machine learning model;
holding the obtained copy of the first machine learning model in at least one memory, and
executing, in response to a request for inference processing for a second device, the inference processing that uses the copy of the first machine learning model held in the at least one memory.

16. An inference processing method executed by an information processing apparatus, the inference processing method comprising:
obtaining a copy of a first machine learning model from a first device that is connected via a communication unit, includes the first machine learning model, and is controlled based on a result of inference processing by the first machine learning model;
holding the obtained copy of the first machine learning model in at least one memory, and
executing, in response to a request for inference processing for a second device, the inference processing that uses the copy of the first machine learning model held in the at least one memory.
